(19) United States
(12) Patent Application Publication
(10) Pub. No.: US 2005/0185708 A1
(43) Pub. Date: Aug. 25, 2005

(54) Apparatus for measuring jitter, method of measuring jitter and computer-readable medium storing a program thereof

(75) Inventors: Takahiro Yamaguchi, Tokyo (JP); Masahiro Ishida, Tokyo (JP); Mani Soma, Seattle, WA (US)

Correspondence Address: OSHA LIANG L.L.P., 1221 MCKINNEY STREET, SUITE 2800, HOUSTON, TX, 77010, US

(73) Assignee: Advantest Corporation, Tokyo (JP)

(21) Appl. No.: 11/060,212

(22) Filed: Feb. 17, 2005

Related U.S. Application Data
(60) Provisional application No. 60/545,697, filed on Feb. 18, 2004.

(51) Int. Cl. H04Q 1/20

(52) U.S. Cl. 375/224

(57) ABSTRACT

A jitter measurement apparatus for measuring the jitter of a signal-under-test includes a squarer for obtaining a squared signal which results from raising the signal-under-test to the 2N-th power (N is a positive integer) and a timing jitter estimator for obtaining a timing jitter sequence of the signal-under-test based on the squared signal.

This patent application claims priority from and the benefits of the earlier filed U.S. Provisional Application Ser. No. 60/545,697, filed Feb. 18, 2004, the contents of which are incorporated herein by reference for all purposes.

### BACKGROUND OF THE INVENTION

1. Field of the Invention

The present invention relates to a jitter measurement apparatus, a jitter measurement method, and a computer-readable medium.

2. Description of the Related Art

Conventionally, as a method fox measuring the jitter of a data signal, an eye diagram measurement method using an oscilloscope has been generally used. FIG. 48 shows an example of the jitter measurement by way of the eye diagram measurement method. In the eye diagram measurement method, a sampling oscilloscope measures the eye diagram of a signal-under-test. Then, from the eye opening, the distribution of transition timing, i.e. the timing jitter of the signal-under-test is obtained. In order to measure timing jitter, the sampling oscilloscope constructs the histogram of timing distribution by counting the number of samples that occur during a specific rectangular time/voltage window.

And recently, real-time digital oscilloscopes capable of measuring jitter using an interpolation method are commercially available. FIG. 49 is a block diagram showing the example configuration of an interpolation-based jitter measurement method.

This jitter measurement method using the interpolation method (the interpolation-based jitter measurement method) is to interpolate the measured data of the sampled signal whose signal level is close to zero-crossing level, and estimate the timing of zero-crossing points. And it is to estimate the ideal timing of the zero-crossing point by estimating the fundamental frequency of the signal-under-test from the measured data. Further, it is to measure the fluctuation of timing by comparing the zero-crossing timing obtained by the interpolation method with the ideal timing.

For measuring a data signal as the signal-under test, there is a difference that the data signal is transmitted unlike the clock signal which repeats the same waveform for each cycle. Due to this difference, in order to measure jitter, it takes time for the jitter measurement method built in the sampling oscilloscope to search the specific sampling point out of the data sequence received. Accordingly, there is a problem that it takes time to acquire a number of data needed for constructing eye diagram and performing histogram analyses.

And in the jitter measurement method combining a wideband real time oscilloscope and the interpolation method, there is a problem that the measured jitter values differ from each other depending on the manufacturer and instrument model (For example, cf. D. Strassberg, “The scope trial”, pages 44 to 54, EDN, Reed Electronics Group, US, published on 6 Feb. 2003).

### SUMMARY OF THE INVENTION

It is an object of the present invention to provide a jitter measurement apparatus and a method thereof that can estimate the value of jitter which is compatible with the conventional eye diagram measurement method in far shorter time, which is capable of overcoming the above drawbacks accompanying the conventional art. The above and other objects can be achieved by combinations described in the independent claims. The dependent claims define further advantageous and exemplary combinations of the present invention.

According to the first aspect of the present invention, a jitter measurement apparatus for measuring jitter of a signal-under-test includes a squarer for obtaining a squared signal which results from raising the signal-under-test to the 2N-th power (N is a positive integer) and a timing jitter estimator for obtaining a timing jitter sequence of the signal-under-test based on the squared signal.

The timing jitter estimator may include a bandwidth limiter for extracting a component near a predetermined frequency band which includes a 2N multiple of a fundamental frequency of the signal-under-test from the squared signal, and obtain the timing jitter sequence with regard to a jitter component of the signal-under-test within the frequency band.

The jitter measurement apparatus may further include a bandwidth determining unit for determining the frequency band based on magnitude of a spectral component of the fundamental frequency of the signal-under-test and a spectral component of a 2N multiple of the fundamental frequency with regard to the squared signal.

The jitter measurement apparatus may further include a carrier amplifier for amplifying a carrier component of the squared signal, which is a 2N multiple of a fundamental frequency of the signal-under-test and a jitter amplitude corrector for correcting amplitude of the timing jitter sequence obtained by the timing jitter estimator based on a ratio at which the carrier component is amplified by the carrier amplifier, wherein the timing jitter estimator obtains the timing jitter sequence based on the squared signal whose carrier component has been amplified.

The timing jitter estimator may include an analytic signal transformer for transforming the squared signal to an analytic signal which is a complex number, an instantaneous phase estimator for obtaining an instantaneous phase of the analytic signal, a linear trend remover for obtaining an instantaneous phase noise by removing a linear phase from the instantaneous phase, and a resampler for resampling data in response to timing which is closest to a predetermined phase of the squared signal among a data sequence of the instantaneous phase noise as instantaneous phase noise data, and outputting the timing jitter sequence, and the analytic signal transformer may include a band-pass filter for removing frequency components except a predetermined frequency band which includes a 2N multiple of the fundamental frequency of the signal-under-test and a Hilbert transformer for generating a Hilbert transform pair of the squared signal, whose component except a predetermined frequency band has been removed, by performing Hilbert transform on the squared signal whose component except the predetermined frequency band has been removed.

The timing jitter estimator may include an analytic signal transformer for transforming the squared signal to an analytic signal which is a complex number, an instantaneous phase estimator for obtaining an instantaneous phase of the analytic signal, a linear trend remover for obtaining an instantaneous phase noise by removing a linear phase from the instantaneous phase, and a resampler for resampling data in response to timing which is closest to a predetermined instantaneous phase of the squared signal among a data sequence of the instantaneous phase noise as instantaneous phase noise data, and outputting the timing jitter sequence, and the analytic signal transformer may include a time domain to frequency domain transformer for transforming the squared signal to a spectrum signal of frequency domain, a bandwidth limiter for extracting components of the spectrum signal near a predetermined frequency band which includes a 2N multiple of a fundamental frequency of the signal-under-test, and a frequency domain to time domain transformer for transforming an output of the bandwidth limiter to the analytic signal of a time domain.

The analytic signal transformer may further include a bandwidth determining unit for determining the frequency band based on magnitude of a spectral component of the fundamental frequency of the signal-under-test, magnitude of a component of a 2N multiple of the fundamental frequency, and inclination of an envelope (amplitude variations) of spectra around the fundamental frequency or a 2N multiple of the fundamental frequency with regard to the spectrum signal.

The bandwidth determining unit may calculate a bandwidth BW of the frequency band based on the following equation, and determine a frequency band with the bandwidth BW whose center is a 2N multiple of the fundamental frequency as the predetermined frequency band:

$$BW = 2 ( 2 {f}_{0} - \frac{3 {Kf}_{0} - L}{2 K} ) ,$$

where f₀ represents the fundamental frequency of the signal-under-test, −K represents the inclination of the amplitude variation of the spectra around the fundamental frequency or the 2N multiple of the fundamental frequency (K represents a decreasing amount in dB/Hz with being apart from the fundamental frequency or the 2N multiple of the fundamental frequency), and L represents a value which results from subtracting magnitude of the 2N-th harmonic (=frequency component at the 2N multiple of the fundamental frequency) from magnitude of the fundamental in dB.

The jitter measurement apparatus may further include an A/D (analog to digital) converter for inputting the signal-under-test of an analog signal and converting the signal-under-test into a digital signal.

The jitter measurement apparatus may further include waveform averaging means for obtaining the signal-under-test, which is averaged, by averaging a data sequence of the signal-under-test for each period in response to the fundamental frequency of the signal-under-test.

According to the second aspect of the present invention, a jitter measurement method for measuring jitter of a signal-under-test by a jitter measurement apparatus includes a squaring step of obtaining a squared signal which results from raising the signal-under-test to the 2N-th power (N is a positive integer) and a timing jitter estimating step of obtaining a timing jitter sequence of the signal-under-test based on the squared signal.

According to the third aspect of the present invention, a computer-readable medium for storing a program for a jitter measurement apparatus for measuring jitter of a signal-under-test, the program allowing the jitter measurement apparatus to function as a squarer for obtaining a squared signal which results from raising the signal-under-test to the 2N-th power (N is a positive integer) and a timing jitter estimator for obtaining a timing jitter sequence of the signal-under-test based on the squared signal.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an example of the power spectrum of a PRBS signal.

FIG. 2 shows a squared signal in the time domain.

FIG. 3 shows the squared signal in the frequency domain.

FIG. 4 shows an example of a signal-under-test.

FIG. 5 shows an example of the squared signal of the signal-under-test.

FIG. 6 shows an example of an analytic signal.

FIG. 7 shows an example of an instantaneous phase.

FIG. 8 shows an example of an instantaneous phase noise.

FIG. 9 shows an example of a timing jitter sequence of the signal-under-test.

FIG. 10 shows an example of an input signal transformed to an analytic signal.

FIG. 11 shows an example of the analytic signal transformed.

FIG. 12 shows an example of an instantaneous phase with a discontinuous point.

FIG. 13 shows an example of an unwrapped continuous instantaneous phase.

FIG. 14 shows an example of a discrete squared signal.

FIG. 15 shows an example of a two-sided power spectrum of the squared signal obtained by FFT.

FIG. 16 shows an example of a band-limited one-sided power spectrum.

FIG. 17 shows an example of a band-limited analytic signal obtained by inverse FFT.

FIG. 18 shows a frequency spectrum of the squared signal.

FIG. 19 shows an example of the approximate zero-crossing points of the signal-under-test.

FIG. 20 shows an example of a clock signal with AM components.

FIG. 21 shows an example of a clock signal without AM components.

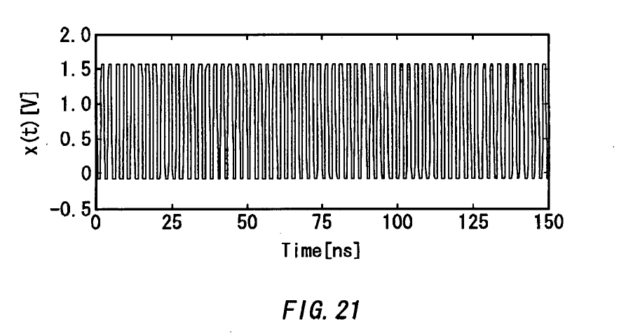

FIG. 22 shows an example of the configuration of the jitter measurement apparatus 100 according to an exemplary embodiment of this invention.

FIG. 23 is a flowchart showing the operation of the jitter measurement method according to an exemplary embodiment of this invention.

FIG. 24 shows the configuration of the jitter measurement apparatus 100 according to a first modified embodiment of this invention.

FIG. 25 is a flowchart showing the operation of the jitter measurement method according to a first modified embodiment of this invention.

FIG. 26 shows an example of the configuration of a timing jitter estimator 102 according to an exemplary embodiment of this invention.

FIG. 27 is a flowchart showing an example of a timing jitter estimating method by way of the timing jitter estimator 102 according to an exemplary embodiment of this invention.

FIG. 28 shows an example of the configuration of an analytic signal transformer 501 according to an exemplary embodiment of this invention.

FIG. 29 is a flowchart showing an example of an analytic signal transformation method by way of the analytic signal transformer 501 according to an exemplary embodiment of this invention.

FIG. 30 shows the configuration of an analytic signal transformer 501 according to a second modified embodiment of this invention.

FIG. 31 is a flowchart showing a timing jitter estimating method by way of the analytic signal transformer 501 according to the second modified embodiment of this invention.

FIG. 32 shows the configuration of an analytic signal transformer 501 according to a third modified embodiment of this invention.

FIG. 33 is a flowchart showing a timing jitter estimating method by way of the analytic signal transformer 501 according to the third modified embodiment of this invention.

FIG. 34 shows the configuration of a jitter measurement apparatus 100 according to a fourth modified embodiment of this invention.

FIG. 35 is a flowchart showing a jitter measurement method by way of the jitter measurement apparatus 100 according to the fourth modified embodiment of this invention.

FIG. 36 shows the configuration of a jitter measurement apparatus 100 according to a fifth modified embodiment of this invention.

FIG. 37 is a flowchart showing a jitter measurement method by way of the jitter measurement apparatus 100 according to the fifth modified embodiment of this invention.

FIG. 38 shows the configuration of a timing jitter estimator 102 according to a sixth modified embodiment of this invention,

FIG. 39 is a flowchart showing a timing jitter estimating method by way of the jitter measurement apparatus 100 according to the sixth modified embodiment of this invention.

FIG. 40 shows the configuration of a jitter measurement apparatus 100 according to a seventh modified embodiment of this invention.

FIG. 41 is a flowchart showing a timing jitter estimating method by way of the jitter measurement apparatus 100 according to the seventh modified embodiment of this invention.

FIG. 42 shows the configuration of waveform averaging means 1901 according to an exemplary embodiment of this invention.

FIG. 43 is a flowchart showing a waveform averaging method by way of the waveform averaging means 1901 according to an exemplary embodiment of this invention.

FIG. 44 shows the configuration of waveform averaging means 1901 according to an eighth modified embodiment of this invention.

FIG. 45 is a flowchart showing a waveform averaging method by way of the waveform averaging means 1901 according to the eighth modified embodiment of this invention.

FIG. 46 compares and shows the measurement results of the jitter measurement method of the present invention and the conventional method.

FIG. 47 shows an example of the hardware configuration of a computer 4900 according to an exemplary embodiment of the present invention.

FIG. 48 shows an example of a jitter measurement by way of an eye diagram measurement method.

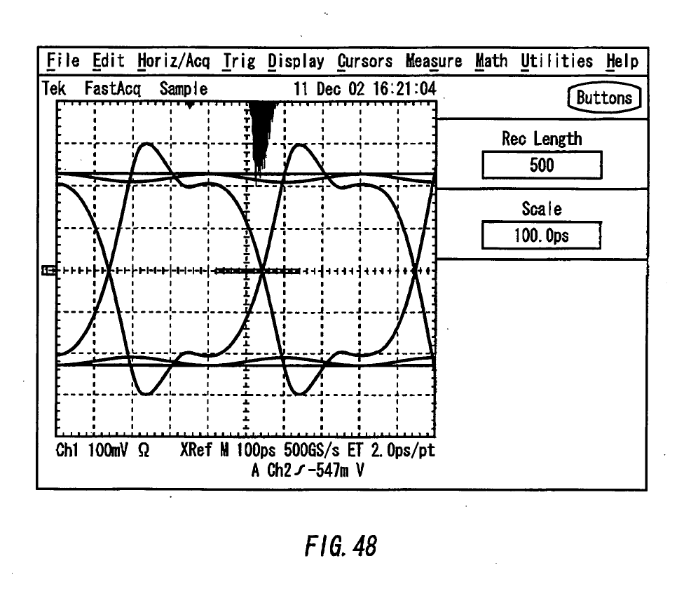

FIG. 49 is a block diagram of a configuration example of the interpolation-based jitter measurement method.

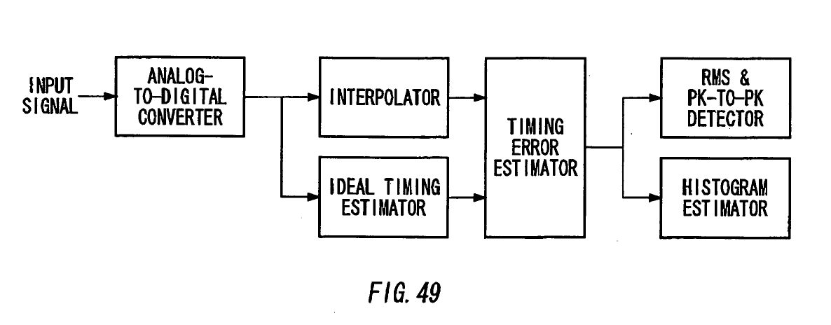

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

Hereafter, the principle of a jitter measurement method according to an exemplary embodiment of the present invention will be described.

(1) Jitter

First of all, jitter will be defined. Jitter corresponds to the fluctuation of the fundamental frequency f₀ of a signal-under-test. Accordingly, jitter analysis is concerned with only the signal component near the fundamental frequency.

The fundamental frequency component of a signal (the signal-under-test) which has jitter is represented by

$$x ( t ) = A cos ( ϕ ( t ) ) = A cos ( \frac{2 π}{{T}_{0}} t + {ϕ}_{0} - Δ ϕ ( t ) ) , \qquad ( 1 )$$

where A is the amplitude, and To is the fundamental period. Here, ø(t) is the instantaneous phase of the signal-under-test, which is represented by the sum of the linear instantaneous phase component 2πt/T₀ including the fundamental period T₀, the initial phase component ø₀ (which can be zero in calculation) and the instantaneous phase noise component Δø(t).

When the instantaneous phase noise component Δø(t) becomes zero, the zero-crossing points at the time of rise of the signal-under-test are distanced from each other by a constant period T₀. Non-zero Δø(t) makes the signal-under-test fluctuate across the zero-crossing points. In other words, Δø(nT₀) at the zero-crossing points nT₀ represents the timing change at the zero-crossing points, and is called timing jitter. Accordingly, by estimating the instantaneous phase ø(t) of the signal-under-test and obtaining the difference between the instantaneous phase at the zero-crossing point and the linear phase (which corresponds to the phase waveform of an ideal clock signal that has no jitter) 2πt/T₀+ø₀. That is, by estimating the instantaneous phase noise component Δø(t), it is possible to calculate the timing jitter of the signal-under-test.

(2) Clock Reproduction Method

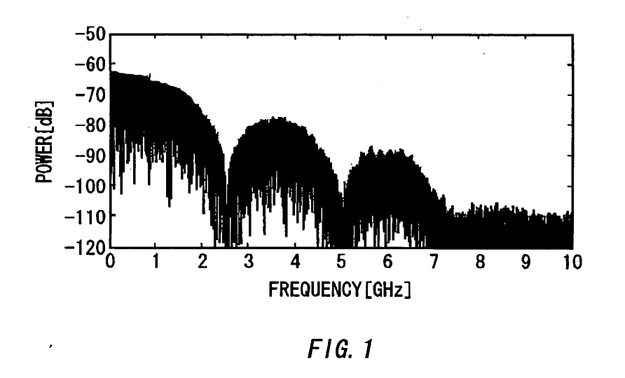

FIG. 1 shows the power spectrum of a PRBS (pseudo-random binary sequence) signal which is an example of a data signal taken as the signal-under-test. The data signal which is to be the signal-under-test, as shown in FIG. 1, generally has its energy over a wide frequency band, and the amplitude of its fundamental frequency component (2.5 GHz in this embodiment) is small. In order to measure the jitter of the signal-under-test with high precision, it is necessary to reconstruct the fundamental frequency component of the signal-under-test. Hereafter, a method for recovering the fundamental frequency component from a data signal will be described.

First, a data signal x(t) is represented by the equation (2), where the data signal is considered as the result from multiplying a random data value aₖ of ±1 by an impulse response of a filter g. Here, the random data value is the data value which is to be the object to be transmitted. And the impulse response of the filter g is determined by the characteristics of the transmitting device or the transmission line.

$$\begin{matrix}x ( t ) = {\sum }_{k = - ∞}^{∞} {a}_{k} g ( t - kT ) \\ {a}_{k} = \{ \begin{matrix}+ 1 \\ - 1\end{matrix}\end{matrix} \qquad ( 2 )$$

Here, T is the fundamental period (symbol timing) of the data signal, and its reciprocal 1/T represents the fundamental frequency of the data signal. If the data signal x(t) is squared, the following equation (3) can be obtained.

$$\begin{matrix}{x}^{2} ( t ) = x ( t ) \cdot x ( t ) \\ = {\sum }_{k} {a}_{k} g ( t - kT ) \cdot {\sum }_{{k}^{′}} {a}_{{k}^{′}} g ( t - {k}^{′} T ) \\ = {\sum }_{k {k}^{′}} {a}_{k} {a}_{{k}^{′}} g ( t - kT ) g ( t - {k}^{′} T )\end{matrix} \qquad ( 3 )$$

Here, since the data value aₖ is a random data of +1 or −1, the following equation (4) is established.
k=k′→aₖ²=1² or(−1)²=1
k≠k′→aₖa_{k′}≡<aₖa_{k′}>=0 (4)

Using the equation (4), the equation (3) can be expressed in the following equation (5).

$$\begin{matrix}{x}^{2} ( t ) = {\sum }_{k {k}^{′}} {δ}_{k {k}^{′}} g ( t - kT ) g ( t - {k}^{′} T ) \\ = {\sum }_{k} {[ g ( t - kT ) ]}^{2}\end{matrix} \qquad ( 5 )$$

Here, δ represents Kronecker δ, and satisfies the following equation (6).
k=k′→δ_{kk′}=1
k≠k′→δ_{kk′}=0 (6)

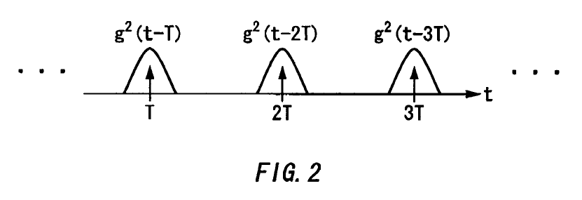

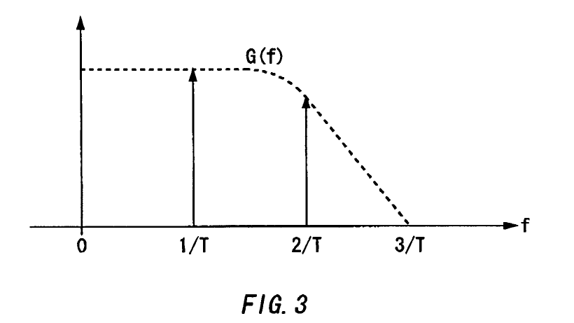

The equation (5) indicates the convolution of a squared waveform g²(t) and a series of impulses as shown in FIG. 2. viewing it in the frequency domain, as shown in FIG. 3, it equals to the multiplication of the series of impulses and the frequency response G(f) which results from squaring the filter, and consequently an impulse appears at a multiple of the frequency of 1/T. In other words, by squaring the data signal waveform, it is possible to recover the fundamental frequency (fundamental clock) component of a data signal and its frequency.

Here, the fundamental frequency component of the data signal x(t) taken as the signal-under-test is represented by the equation (1). If the data signal x(t) is only the fundamental frequency component, the squared signal x²(t) of the data signal x(t) can be represented by the following equation (7).

$$\begin{matrix}{x}^{2} ( t ) = {A}^{2} {cos}^{2} ( \frac{2 π}{{T}_{0}} t + {ϕ}_{0} - Δ ϕ ( t ) ) \\ = \frac{{A}^{2}}{2} ( 1 + cos 2 \cdot ( \frac{2 π}{{T}_{0}} t + {ϕ}_{0} - Δ ϕ ( t ) ) )\end{matrix} \qquad ( 7 )$$

In other words, it can be found that the fundamental frequency component of the signal-under-test is transformed to the component at

$$2 ( \frac{1}{{T}_{0}} ) .$$

Meanwhile, the instantaneous phase noise component Δø(t) of the signal-under-test is preserved. Accordingly, by obtaining the instantaneous phase noise of the component at

$$2 ( \frac{1}{{T}_{0}} )$$

with regard to the squared signal, it is possible to obtain the jitter of the original signal-under-test.

As above, if the data signal which is to be the signal-under-test is the PRBS signal, the amplitude of the fundamental frequency component is small as shown in FIG. 1. Accordingly, in the jitter measurement method related to this embodiment, the jitter of the signal-under-test is obtained by recovering the frequency components at the fundamental frequency and

$$2 ( \frac{1}{{T}_{0}} )$$

by squaring the data signal and then measuring the jitter component included in near the frequency component around the

$$2 ( \frac{1}{{T}_{0}} ) .$$

Further, in the method for recovering the fundamental clock component from the data signal, the data signal may be raised to the 2N-th (N is a positive integer) power to reconstruct its clock component. At this time, by obtaining the instantaneous phase noise of the 2N multiple of the fundamental frequency of the signal-under-test which has been raised to the 2N-th power, it is possible to obtain the jitter of the original signal-under-test.

(3) Jitter Measurement Method

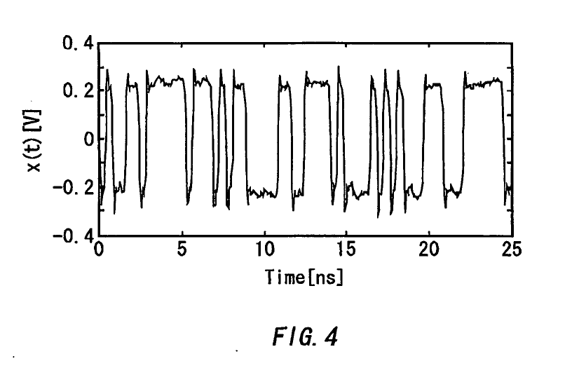

The jitter measurement method of the present invention is to raise the signal-under-test x(t) to the 2N-th power shown in FIG. 4 and transform it to the squared signal at the first time. Hereafter, the method will be described if N=1.

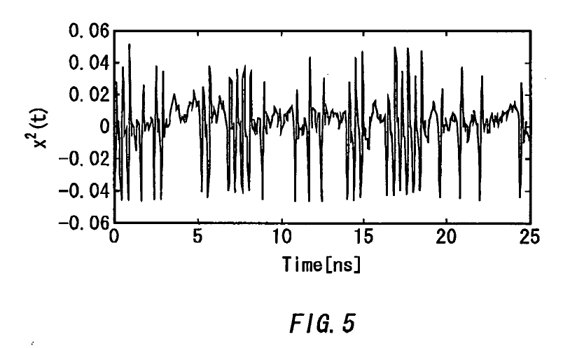

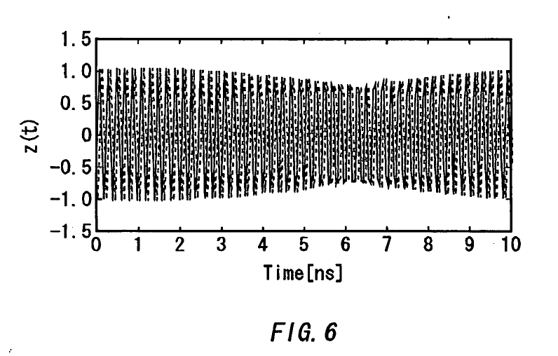

FIG. 5 shows the squared signal x²(t) which results from squaring the signal-under-test shown in FIG. 4. Then, the squared signal x²(t) is transformed to an analytic signal z(t) which is a complex number. When the squared signal is transformed to the analytic signal, the analytic signal may be obtained by amplifying the frequency component of the squared signal whose frequency is two times the carrier frequency of the signal-under-test (2N multiple in case of the squared signal x^{2N}(t)) with a predetermined amplification ratio A. At this time, since the energy of the instantaneous phase noise obtained from the analytic signal becomes 1/A, it is necessary to correct the estimated value of the timing jitter in response to the amplification rate A. FIG. 6 shows the analytic signal z(t) which is transformed from the squared signal x²(t) in FIG. 5. In FIG. 6, the continuous line represents the real part of the analytic signal, and the dotted line represents the imaginary part of the analytic signal.

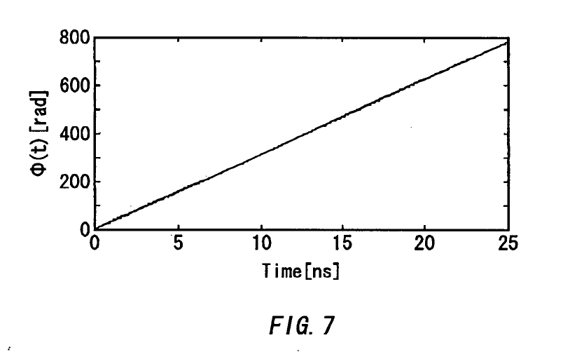

Then, the instantaneous phase ø(t) of the signal-under-test x(t) is estimated from the analytic signal z(t). FIG. 7 shows the instantaneous phase waveform ø(t) estimated from the analytic signal z(t) in FIG. 6.

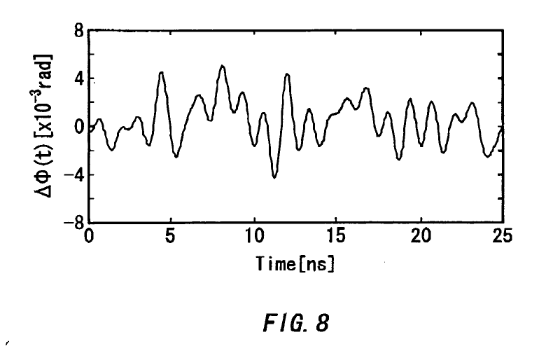

Then, a least-squares fit of a straight line to the data of the instantaneous phase waveform is performed, and the linear instantaneous phase øₗᵢₙₑₐᵣ(t) is obtained. The linear instantaneous phase corresponds to the jitter-free instantaneous phase waveform of an ideal signal. Then, the difference between the instantaneous phase ø(t) and the linear instantaneous phase øₗᵢₙₑₐᵣ(t) is calculated so as to obtain the instantaneous phase noise Δø(t) of the signal-under-test. FIG. 8 shows the instantaneous phase waveform noise Δø(t) obtained from the instantaneous phase ø(t) in FIG. 7.

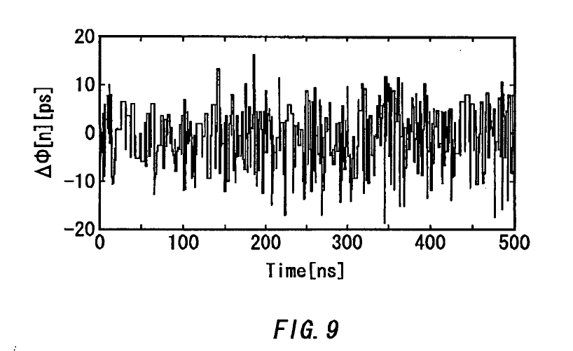

Then, the instantaneous phase waveform noise Δø(t) is sampled at the timing (approximate zero-crossing point) which is closest to each zero-crossing point of the real part x(t) of the analytic signal z(t). That is, the instantaneous phase noise at the zero-crossing timing nT₀ is measured. It corresponds to the timing jitter Δø[n] (=Δø(nT₀)). FIG. 9 shows the timing jitter sequence Δø[n] measured from the instantaneous phase waveform noise Δø(t) in FIG. 8.

Then, the RMS value and peak to peak value of the timing jitter are measured from the timing jitter sequence Δø[n]. The RMS timing jitter Δø_{RMS} which is root-mean-square of the timing jitter Δø[n] can be calculated by the following equation (8).

$$Δ {ϕ}_{RMS} = \sqrt{\frac{1}{N} {\sum }_{k = 1}^{N} Δ {ϕ}^{2} [ k ]} [ rad ] \qquad ( 8 )$$

Here, N is the number of data samples of the timing jitter measured.

And the peak to peak timing jitter Δøₚₚ which is the difference between the maximum and minimum values of Δø[n] can be calculated by the following equation (9).

$$Δ {ϕ}_{PP} = {max}_{k} ( Δ ϕ [ k ] ) - {min}_{k} ( Δ ϕ [ k ] ) [ rad ] \qquad ( 9 )$$

In addition, the jitter measurement method of the present invention is to remove an amplitude modulation (AM) component of the signal-under-test and then leave only a phase modulation (PM) component in response to the jitter, so that the jitter can also be estimated with higher precision.

And the jitter measurement method of the present invention may use a low frequency component remover, which removes low frequency components in the instantaneous phase noise of the signal-under-test so as to obtain the jitter. Accordingly, it is possible to remove the jitter of a low frequency such as power supply fluctuation and to increase the repetability of the jitter measurement.

(4) Instantaneous Phase Estimation Method Using Analysis signal

The analytic signal z(t) transformed from a real signal y(t) is defined as the complex signal represented by the following equation (10).
z(t)≡y(t)+jŷ(t) (10)

Here, j is the imaginary unit, and the imaginary part ŷ(t) of the complex signal z(t) is the Hilbert transform of the real part y(t).

Meanwhile, the Hilbert transform of the real signal y(t) is defined as the following equation.

$$\hat{y} ( t ) = H [ y ( t ) ] = \frac{1}{π} {\int }_{- ∞}^{+ ∞} \frac{y ( τ )}{t - τ} ⅆ τ \qquad ( 11 )$$

Here, ŷ(t) is the convolution of the function y(t) and (1/πt). In other words, the Hilbert transform is equivalent to the output of an all-pass filter when y(t) passes through it. However, the phase of the output ŷ(t) at that time is shifted by π/2, whereas the magnitude of the spectrum component is unchanged.

The analytic signal and the Hilbert transform are present in “A. Papoulis, Probability, Random Variables, and Stochastic Processes, 2nd edition, McGraw-Hill Book Company, 1984”.

The instantaneous phase waveform ø(t) of the real signal y(t) is obtained from the analytic signal z(t) using the following equation (12).

$$ϕ ( t ) = {tan}^{- 1} [ \frac{\hat{y} ( t )}{y ( t )} ] \qquad ( 12 )$$

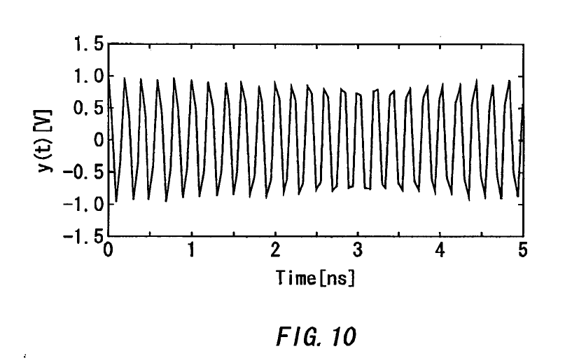

Then, an algorithm for estimating the instantaneous phase of the squared signal y(t)=x²(t) using Hilbert transform will be described. First, the squared signal y(t) shown in FIG. 10 is represented by the following equation (13).

$$y ( t ) = \frac{{A}^{2}}{2} cos 2 \cdot ( \frac{2 π}{{T}_{0}} t + {ϕ}_{0} - Δ ϕ ( t ) ) \qquad ( 13 )$$

By applying Hilbert transform to the squared signal y(t) of the equation (13), the signal which responds to the imaginary part of the complex signal and is represented by the following equation (14) can be obtained.

$$\hat{y} ( t ) = H [ y ( t ) ] = \frac{{A}^{2}}{2} sin 2 \cdot ( \frac{2 π}{{T}_{0}} t + {ϕ}_{0} - Δ ϕ ( t ) ) \qquad ( 14 )$$

Using the equation (14), the input signal y(t) can be transformed to the analytic signal z(t) represented by the following equation (15).

$$\begin{matrix}z ( t ) = y ( t ) + j \hat{y} ( t ) \\ = \frac{{A}^{2}}{2} cos 2 \cdot ( \frac{2 π}{{T}_{0}} t + {ϕ}_{0} - Δ ϕ ( t ) ) + \\ j \frac{{A}^{2}}{2} sin 2 \cdot ( \frac{2 π}{{T}_{0}} t + {ϕ}_{0} - Δ ϕ ( t ) )\end{matrix} \qquad ( 15 )$$

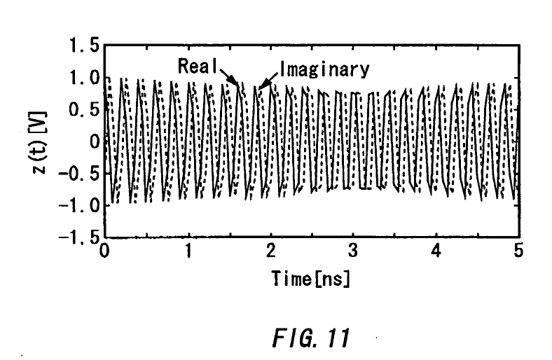

The analytic signal transformed is shown in FIG. 11. Here, band-pass filtering is performed on the analytic signal shown in FIG. 11. That is why jitter analysis deals with only the frequency component of the squared signal x²(t) whose frequency is two times the carrier frequency of the signal-under-test (2N multiple in case of the squared signal x^{2N}(t)), because the jitter corresponds to the fluctuation of the fundamental frequency of the signal-under-test.

Then, the phase function Φ(t) represented by the following equation (16) is estimated from the analytic signal z(t) obtained using the equation (12).

$$Φ ( t ) = 2 \cdot [ \frac{2 π}{{T}_{0}} t + {ϕ}_{0} - Δ ϕ ( t ) ] mod 2 π [ rad ] \qquad ( 16 )$$

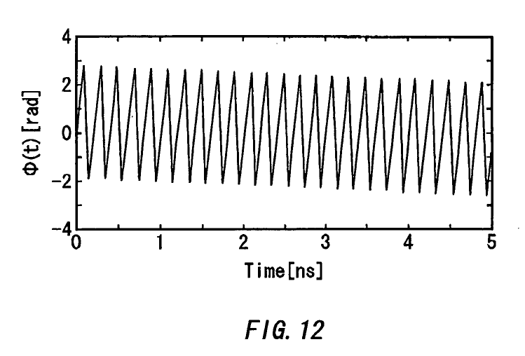

Here, Φ(t) is represented by a principal value of phase ranging from −π to +π, and it has a discontinuous point near the change from +π to −π. The phase function Φ(t) estimated is shown in FIG. 12.

Lastly, by unwrapping the discontinuous phase function Φ(t) (i.e. properly adding integer multiples of 2π to the principal value), the continuous instantaneous phase ø(t) without discontinuities can be obtained. The continuous instantaneous phase ø(t) is represented by the following equation (17).

$$ϕ ( t ) = 2 \cdot ( \frac{2 π}{{T}_{0}} t + {ϕ}_{0} - Δ ϕ ( t ) ) [ rad ] \qquad ( 17 )$$

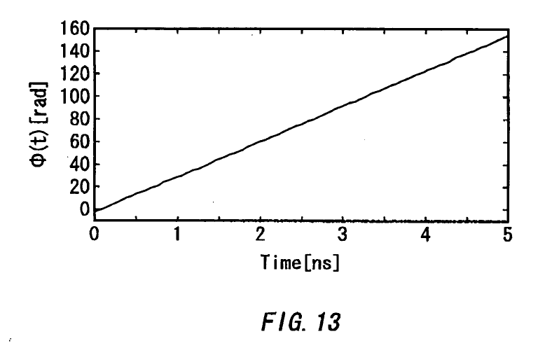

The phase unwrapping method is present in “Donald G. Childers, David P. Skinner and Robert C. Kemerait, “The Cepstrum: A Guide to Processing”, Proceedings of IEEE, vol. 65, pp. 1428-1442, 1977”. FIG. 13 shows the unwrapped continuous instantaneous phase function ø(t).

(5) Transformation into Analytic Signal Using Fast Fourier Transform

The transformation from a real signal into the analytic signal is also achieved by digital signal processing using Fast Fourier Transform.

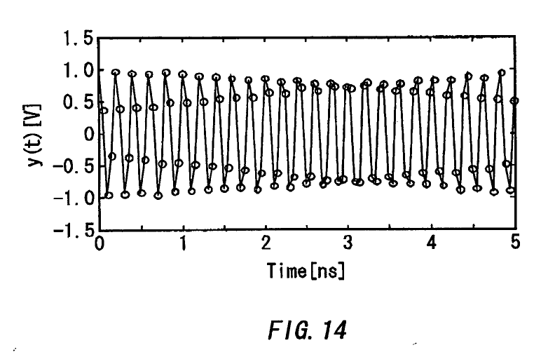

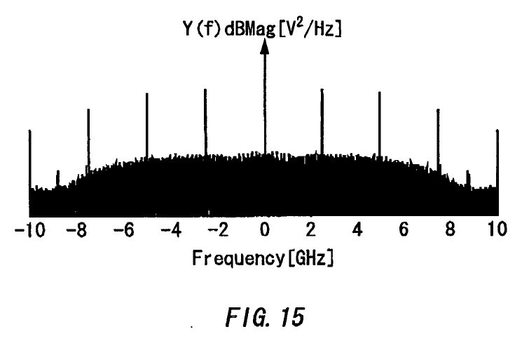

First, by applying FFT to the digitized squared signal y(t)=x²(t) shown in FIG. 14, a two-sided spectrum signal (having both positive and negative frequencies)of the input signal is obtained. FIG. 15 shows the two-sided spectrum signal Y(f) obtained.

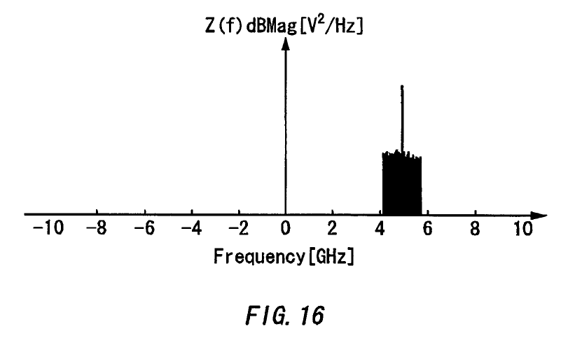

Then, only the spectral data y(f) at around the frequency+2×(carrier frequency) (generally, 2N multiple in case of the squared signal x^{2N}(t)) is kept, other data becomes zero, and the positive frequency components are multiplied by two. This process in the frequency domain corresponds to band limitation and transformation of the signal-under-test into the analytic signal in the time domain. FIG. 16 shows a signal Z(f) of the frequency domain obtained.

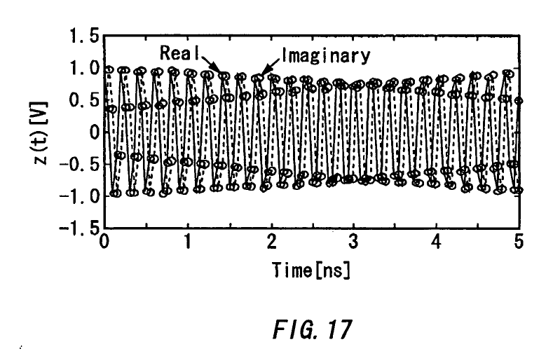

Lastly, by applying inverse FFT to the signal Z(f) obtained, the band-limited analytic signal z(t) can be obtained. FIG. 17 shows the band-limited analytic signal z(t).

The transformation into the analytic signal using FFT is present in “J. S. Bendat and A. G. Piersol, Random Data: Analysis and Measurement Procedure, 2nd edition, John Wiley & Sons, Inc., 1986”.

And in case that the purpose is the instantaneous phase estimation, the process of multiplying the positive frequency component by two can be omitted.

(6) Determination of Frequency Band

In order to measure jitter with regard to the fundamental frequency of the signal-under-test in the above (4) or (5), the frequency band of the jitter component under test is limited to the frequency band including the 2N multiple of the signal-under-test with regard to the squared signal. For example, in the above (4), when the squared signal shown in FIG. 10 is transformed to the analytic signal shown in FIG. 11, the band-pass filtering process is performed. And in the above (5), the bandwidth of the two-sided spectrum signal shown in FIG. 15 is limited so as to obtain the analytic signal of the frequency domain shown in FIG. 16.

This frequency band can be a predetermined frequency range. However, in order to measure the jitter of the signal-under-test more properly, it is preferable to determine the frequency band suitable for the signal-under-test. Hereafter, the method for determining the frequency band of the jitter component under test will be shown.

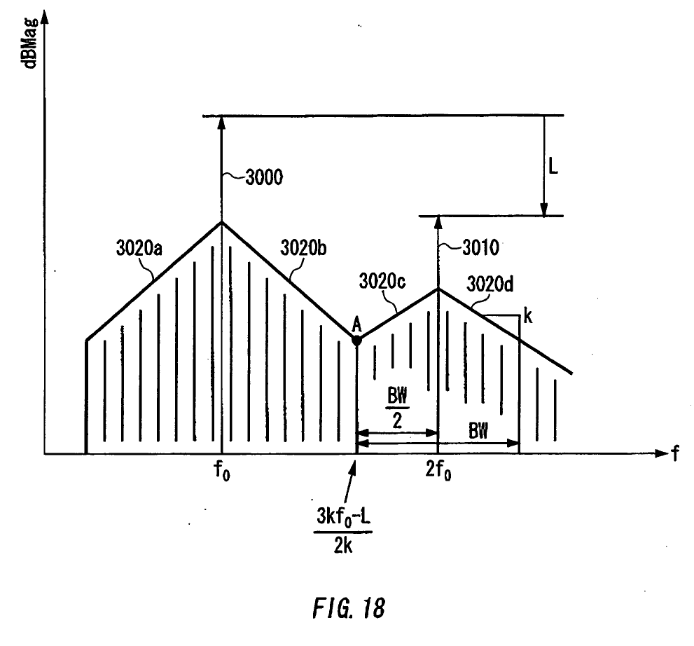

FIG. 18 illustrates the frequency spectrum of the squared signal if the N is 1. The f₀ component 3000 is the frequency component of the squared signal corresponding to the fundamental frequency f₀ of the signal-under-test. The 2f₀ component 3010 is the frequency component of the squared signal corresponding to the frequency 2f₀ which is two times (the 2N multiple if N is not 1) the frequency of the signal-under-test. In order to measure the jitter of the signal-under-test, the band limiting processing is performed as the jitter component present around the frequency which is the 2N multiple of the frequency of the signal-under-test is extracted.

Here, since the jitter component is the fluctuation in the frequency component relative to with respect to the reference frequency, it can be considered to be proportional to the amplitude of the reference frequency component. Accordingly, the frequency band which is to be the object to be measured can be determined on the basis of the magnitude of the f₀ component 3000 and the 2f₀ component 3010 in the squared signal.

And, the frequency band can be further determined on the basis of the slope of the spectral envelopes 3020a to 3020d near the f₀ component 3000 and/or the 2f₀ component 3010. Here, since the jitter of the signal-under-test is the fluctuation with respect to the fundamental frequency f₀, the amplitude value of the envelopes 3020a and 3020b become generally small as apart from the f₀ component 3000. In the same way, the amplitude value of the envelopes 3020c and 3020d become generally small as apart from the 2f₀ component 3010.

Accordingly, in the jitter measurement method related to this embodiment, the point A at which the envelopes 3020b and 3020c are crossing each other. It is considered that the effect of the f₀ component 3000 is large with regard to the frequencies closer to the f₀ component 3000 than the point A, whereas the effect of the 2f₀ component 3010 is large with regard to the frequencies closer to the 2f₀ component 3010 than the point A. In order to extract the jitter component from the frequency component of the 2N multiple of the signal-under-test, the frequency band whose lower limit frequency corresponds to the frequency of the point A and whose center is the 2f₀ component 3010 is determined as the frequency band under measurement.

More particularly, the value L (a negative value in this figure) is obtained by subtracting the magnitude of the 2f₀ component 3010 from the magnitude of the f₀ component 3000. Then, over frequencies near the fundamental frequency f₀ and/or the component of the frequency 2f₀ which is two times the fundamental frequency, the decreasing amount K from the amplitude value of the embelopes is obtained by scanning frequency as much as the unit frequency in the direction apart from the frequencies. The K is the slope of the envelope(s) 3020a and/or 3020c, whereas −K is the slope of the envelope(s) 3020b and/or 3020d.

And the bandwidth BW of the frequency band is calculated as shown in the following equation (18) on the basis of the values K and L.

$$BW = 2 ( 2 {f}_{0} - \frac{3 {Kf}_{0} - L}{2 K} ) \qquad ( 18 )$$

(7) Method for Detecting Approximate Zero-Crossing Points

Next, a method for detecting approximate zero-crossing points will be described. First, a signal level V_{50%} which is the 50% level is calculated as the level of the zero-crossing, where the maximum value of the input signal-under-test x(t) is the 100% level, the minimum value is the 0% level.

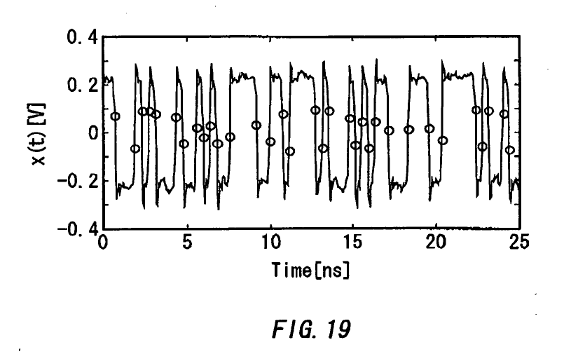

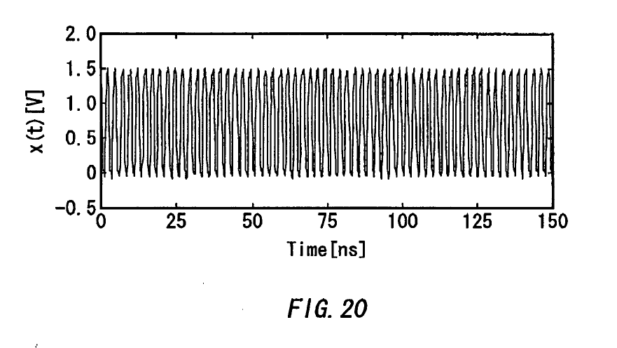

Then, the differences (x(j−1)−V_{50%}) and (x(j)−V_{50%}) between the values of the samples adjacent to x(t) and the 50% level V_{50%} are obtained, and their product (x(j−1)−V_{50%})×(x(j)−V_{50%}) is calculated. When x(t) is the 50% level and crosses the zero-crossing level, the sign of its sample values (x(j−1)−V_{50%}) and (x(j)−V_{50%}) becomes positive from negative or negative from positive, so when the product becomes negative, x(t) crosses the zero-crossing level, and the time j−1 or j whose absolute value of the sample value (x(j−1)−V_{50%}) or (x(j)−V_{50%}) is smaller than the other can be obtained as the approximate zero-crossing point. FIG. 19 shows the waveform of the real part x(t) of the analytic signal. The marks o in FIG. 20 show the points which are detected as being closest to the zero-crossing points (detected as being approximate zero-crossing points).

(8) Waveform Clipping

The waveform clipping is the process of removing AM components from the input signal so as to leave only PM components corresponding to the jitter. The waveform clipping is realized by the following process on the analog or digital input signal.

First, the value of the input signal is multiplied by a constant. Then, the signal value larger than a predetermined threshold 1 is replaced by the threshold 1, whereas the signal value smaller than a predetermined threshold 2 is replaced by the threshold 2. Here, the threshold 1 is to be larger than the threshold 2.

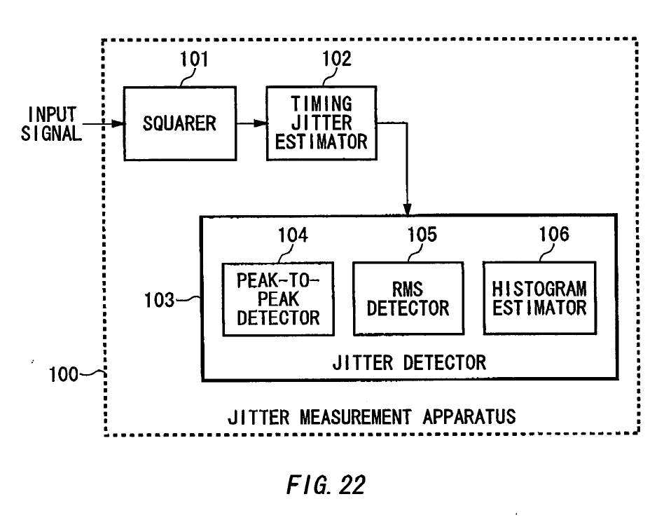

FIG. 20 shows the clock signal with the AM component. From that, since the envelope of the time waveform is changing, it can be seen that the AM components exist in it. FIG. 22 shows the clock signal on which the waveform clipping has been performed. Since the time waveform shows a constant envelope, it can be confirmed that the AM components are removed from it.

(9) Waveform Averaging

When the data signal is transmitted through a cable, a jitter component which occurs at the cable terminal caused by the data pattern and the effect of the transmission characteristics of the cable is called data dependent jitter or deterministic jitter. The jitter component is time invariant, though the data series is shifted along time-axis as much as a period T_{seq}. Meanwhile, the random jitter component and the data series have no correlation with each other. Accordingly, if the jitter component synchronously measured with the period T_{seq} of the data series is averaged in the time domain, the random jitter component can be removed, and only the deterministic jitter component can be estimated.

However, the period of the data series is generally not an integer multiple of a sampling period, and for example, it is shifted from a sampling impulse as much as Δτ (which is not an integer multiple of the sampling period). At this time, by performing Fourier transform on the time waveform x(t), rotating the phase angle of the spectrum signal X(f) by exp(−j2πfΔτ), and performing inverse Fourier transform, the waveform x(t−Δτ) which results from shifting the original waveform in time can be obtained. When averaging is performed using the waveform, the signal waveform of the data series can be properly averaged regardless of the sampling period.

The averaging process may be performed in the time domain, or performed by averaging the complex spectrum in the frequency domain. That is, Fourier transform is first performed on the time waveform x(t), and the phase angle of the spectrum signal X(f) is rotated as much as exp(−j2πfΔτ). Then, the complex spectrum whose phase has been rotated is averaged. Then, the averaged time waveform is first obtained by performing inverse Fourier transform on the complex spectrum averaged.

The jitter measurement apparatus and the jitter measurement method will be hereafter shown on the basis of the above principle.

FIG. 22 shows an example of the configuration of the jitter measurement apparatus 100 according to an exemplary embodiment of this invention. The jitter measurement apparatus 100 includes a squarer 101 which is a device for measuring the jitter of a signal-under-test, a timing jitter estimator 102, and a jitter detector 103. The squarer 101 obtains the squared signal by raising the inputted signal-under-test to the 2N-th power (N is a positive integer). The timing jitter estimator 102 obtains the timing jitter sequence of the signal-under-test on the basis of the squared signal.

The jitter detector 103 obtains the jitter value of the signal-under-test on the basis of the timing jitter sequence of the signal-under-test. The jitter detector 103 includes a peak to peak detector 104, an RMS detector 105, and/or a histogram estimator 106. The peak to peak detector 104 obtains the difference between the maximum and minimum values of the timing jitter sequence of the signal-under-test. The RMS detector 105 obtains the mean square value of the timing jitter sequence of the signal-under-test. The histogram estimator 106 obtains the histogram of the timing jitter sequence of the signal-under-test.

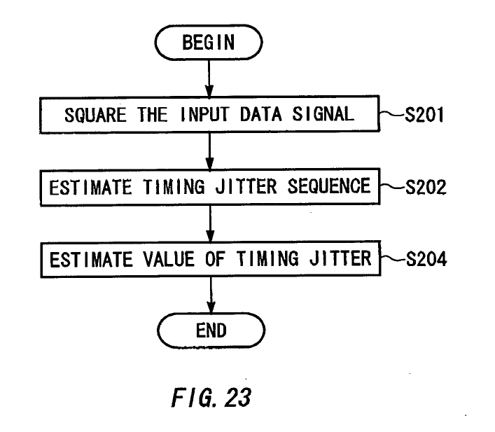

FIG. 23 is a flowchart showing the operation of the jitter measurement method realized by the jitter measurement apparatus 100 according to an exemplary embodiment. First, the squarer 101 obtains the squared signal of the inputted signal-under-test (step S201). Then, the timing jitter estimator 102 obtains the timing jitter sequence of the signal-under-test from the squared signal (S202).

And the jitter detector 103 obtains the timing jitter of the signal-under-test from the timing jitter sequence (step S202). In S203, the peak to peak detector 104 obtains the peak to peak value of the timing jitter using the equation (9). The RMS detector 105 obtains the RMS value of the timing jitter using the equation (8). And the histogram estimator 106 obtains the histogram which shows the distribution of the magnitude of the timing jitter from the timing jitter sequence.

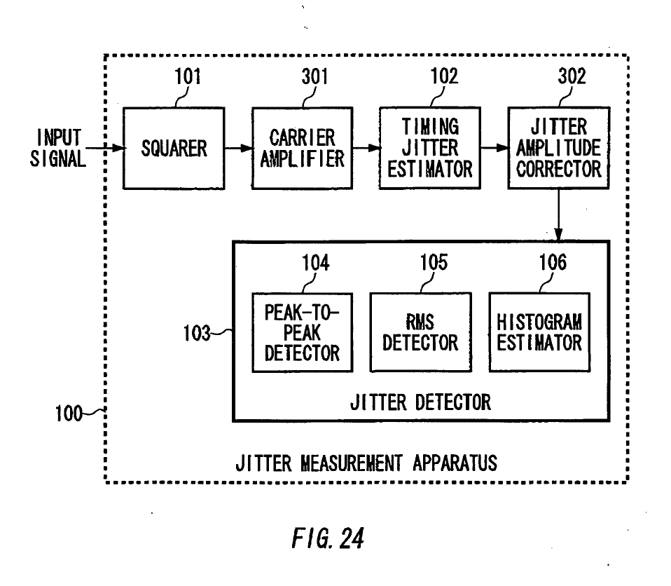

FIG. 24 shows the configuration of the jitter measurement apparatus 100 according to a first modified embodiment of this invention. The jitter measurement apparatus 100 according to this embodiment includes a carrier amplifier 301, a timing jitter estimator 102, a jitter amplitude corrector 302, and a jitter detector 103. In the jitter measurement apparatus 100 according to this embodiment, members of the same symbols as those in FIG. 22 have the same function and configuration as those in FIG. 22, so they will not be described except the difference.

The carrier amplifier 301 receives the squared signal outputted by the squarer 101, amplifies the carrier component of the squared signal whose frequency is the 2N multiple of the fundamental frequency of the signal-under-test, and supplies the signal to the timing jitter estimator 102. The jitter amplitude corrector 302 corrects the amplitude of the timing jitter sequence obtained by the timing jitter estimator 102 based on the ratio at which the carrier component is amplified by the carrier amplifier 301.

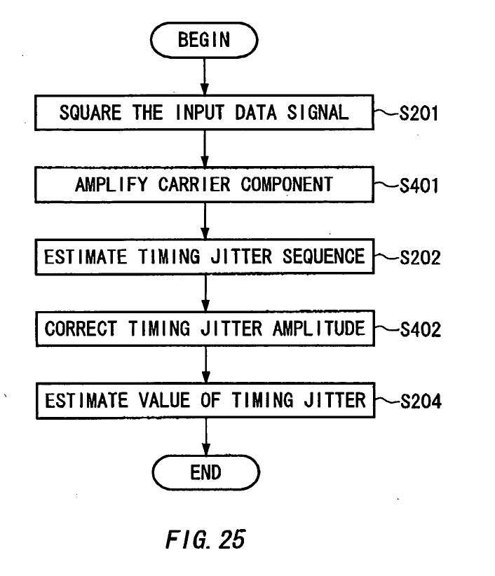

FIG. 25 is a flowchart showing the operation of the jitter measurement method according to a first modified embodiment of this invention. In the jitter measurement method according to this embodiment, steps of the same symbols as those in FIG. 23 are the same as the steps where the process in FIG. 23 is performed, so they will not be described except the difference.

The carrier amplifier 301 receives the squared signal obtained by the squarer 101 in S201, and amplifies the carrier component of the squared signal whose frequency is the 2N multiple of the fundamental frequency of the signal-under-test (S401). More particularly, the carrier amplifier 301 amplifies the carrier frequency component as much as a predetermined amplification ratio A as shown in the principle (3) of the jitter measurement method.

Then, the timing jitter estimator 102 obtains the timing jitter sequence on the basis of the squared signal whose carrier component has been amplified by the carrier amplifier 301 (S202). And the jitter amplitude corrector 302 corrects the amplitude of the timing jitter sequence obtained by the timing jitter estimator 102 on the basis of the amplification ratio of the carrier component by the carrier amplifier 301 (S402). More particularly, the jitter amplitude corrector 302 corrects the amplitude of the timing jitter sequence by multiplying the timing jitter sequence by the amplification ratio A of the carrier by the carrier amplifier 301 in S402.

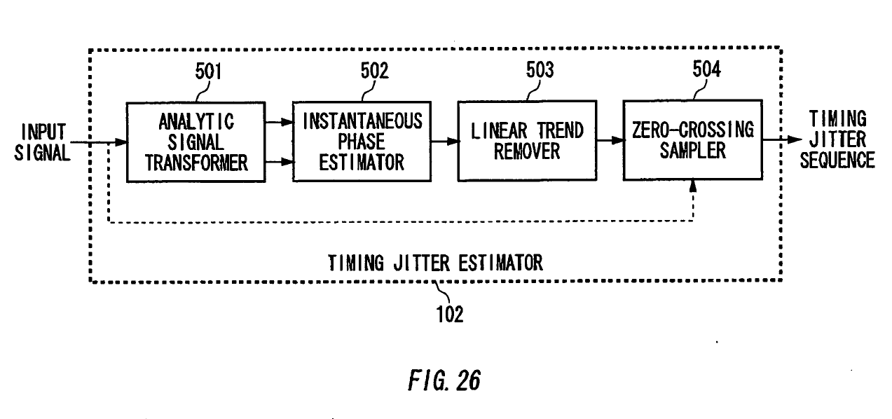

FIG. 26 shows an example of the configuration of the timing jitter estimator 102 according to this embodiment. The timing jitter estimator 102 includes an analytic signal transformer 501, an instantaneous phase estimator 502, a linear trend remover 503, and a zero-crossing sampler 504.

The analytic signal transformer 501 transforms the input signal to the analytic signal of a complex number. The instantaneous phase estimator 502 obtains the instantaneous phase of the analytic signal. The linear trend remover 503 removes the linear phase from the instantaneous phase and obtains the instantaneous phase noise. The zero-crossing sampler 504, which is an example of the resampler according to this invention, resamples the data which is close to predetermined timing of the signal-under-test among the data sequence of the instantaneous phase noise as the instantaneous phase noise data, and outputs a timing jitter sequence.

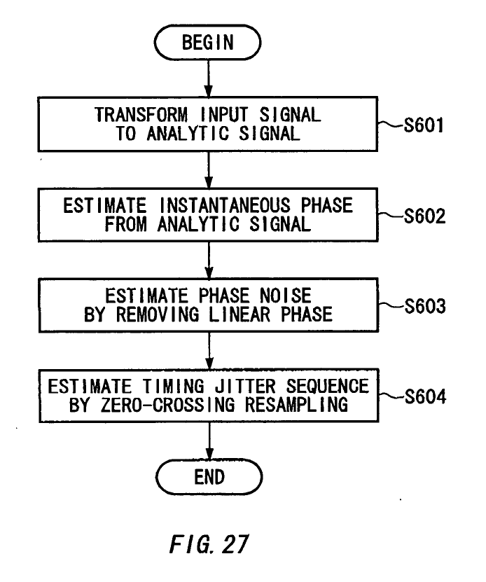

FIG. 27 is a flowchart showing an example of a timing jitter estimating method by way of the timing jitter estimator 102 according to an exemplary embodiment of this invention. First, the analytic signal transformer 501 transforms the squared signal inputted from the squarer 101 or the squared signal which is inputted from the carrier amplifier 301 and whose carrier component has been amplified to the analytic signal of a complex number by selectively passing its predetermined frequency component (S601). Then, the instantaneous phase estimator 502 estimates the instantaneous phase of the signal-under-test on the basis of the analytic signal outputted from the analytic signal transformer 501 (S602). In other words, the instantaneous phase estimator 502 obtains the instantaneous phase represented in the equation (16) from the analytic signal using the equation (12).

Then, the linear trend remover 503 estimates the linear phase from the instantaneous phase outputted from the instantaneous phase estimator 502 and obtains the instantaneous phase noise (S603). More particularly, the linear trend remover 503 first estimates the linear instantaneous phase which is the linear phase in response to an ideal clock signal from the instantaneous phase outputted from the instantaneous phase estimator 502. Then, the linear trend remover 503 estimates the instantaneous phase noise by removing the linear instantaneous phase from the instantaneous phase unwrapped.

Then, the zero-crossing sampler 504 resamples the data which is close to the predetermined timing of the signal-under-test among the data sequence of the instantaneous phase noise as the instantaneous phase noise data, estimates and outputs the timing jitter sequence. More particularly, the zero-crossing sampler 504 samples the data in response to the timing of the squared signal which is closest to a predetermined phase as the instantaneous phase noise data.

Here, the zero-crossing sampler 504 may resample only the data which is close to the zero-crossing timing of the signal-under-test, or alternatively may resample only the data which is close to the zero-crossing timing of the squared signal of the signal-under-test. Alternatively, the zero-crossing sampler 504 may resample the data for each ¼N multiple of the fundamental period of the signal-under-test or at other timing.

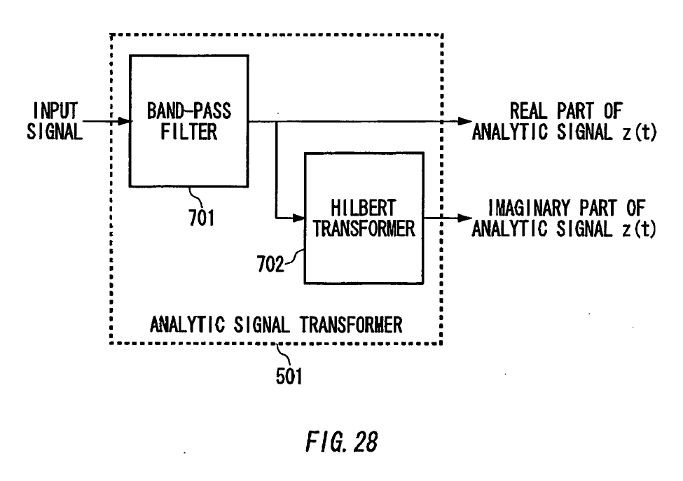

FIG. 28 shows an example of the configuration of an analytic signal transformer 501 according to this embodiment. The analytic signal transformer 501 includes a band-pass filter 701 and a Hilbert transformer 702. The analytic signal transformer 501 selects only the component near a predetermined frequency from the inputted squared signal, and limits the bandwidth of the input signal. Here, the analytic signal transformer 501 may be either an analog or digital filter, or may be implemented by way of digital signal processing such as FFT. The Hilbert transformer 702 generates a Hilbert transform pair of the squared signal by performing Hilbert transform on the squared signal band-limited by the band-pass filter 701.

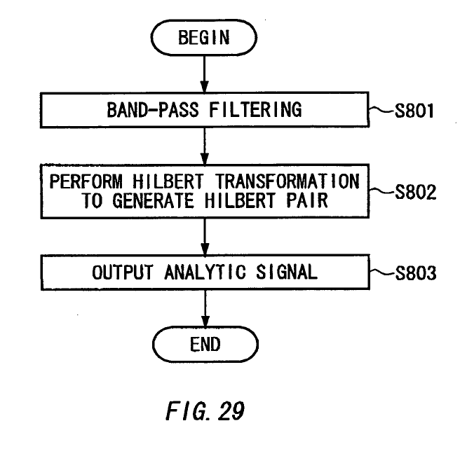

FIG. 29 is a flowchart showing an example of an analytic signal transformation method by way of the analytic signal transformer 501 according to an exemplary embodiment of this invention. First, the band-pass filter 701 selects only the component near a predetermined frequency from the inputted squared signal so as to limit the bandwidth of the input signal (S801). More particularly, the band-pass filter 701 selects a predetermined frequency band including the 2N multiple of the fundamental frequency of the signal-under-test from the inputted squared signal and removes the component except the frequency band.

Then, the Hilbert transformer 702 applies Hilbert transform to the squared signal band-limited by the band-pass filter 701 to generate a Hilbert transform pair of the squared signal (S802). More particularly, the Hilbert transformer 702 performs Hilbert transform on the squared signal from which the component except the predetermined frequency band has been removed, and generates a Hilbert transform pair of the squared signal in response to the imaginary part of the analytic signal.

And the analytic signal transformer 501 outputs the output signal of the band-pass filter 701 taken as the real part of the analytic signal and the output signal of the Hilbert transformer 702 taken as the imaginary part of the analytic signal (S803).

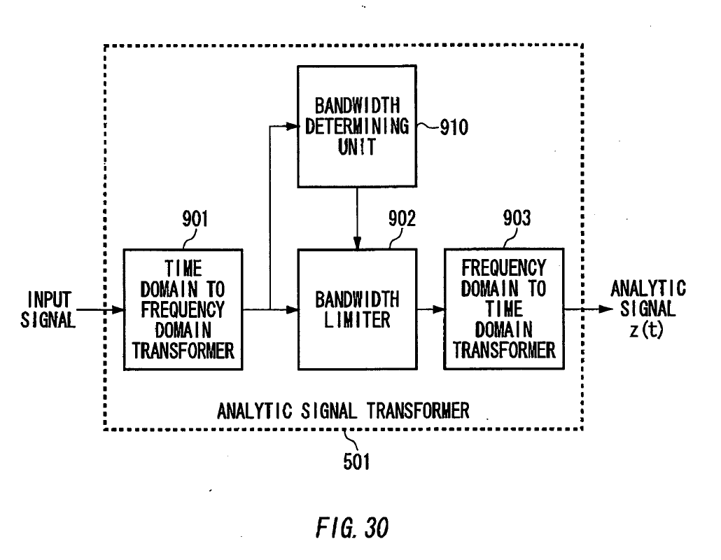

FIG. 30 shows the configuration of an analytic signal transformer 501 according to a second modified embodiment of this invention. The analytic signal transformer 501 of this modified embodiment includes a time domain to frequency domain transformer 901, a bandwidth limiter 902, and a frequency domain to time domain transformer 903.

The time domain to frequency domain transformer 901 transforms the squared signal to a two-sided spectrum signal of the frequency domain. The bandwidth limiter 902 selects the component near a predetermined frequency of the two-sided spectrum signal of the frequency domain. The frequency domain to time domain transformer 903 performs inverse transformation on the output of the bandwidth limiter 902 to the analytic signal of the time domain. The time domain to frequency domain transformer 901 and the frequency domain to time domain transformer 903 may perform transformation between the time and frequency domains by way of FFT and inverse FFT respectively.

In addition, the analytic signal transformer 501 may further include a bandwidth determining unit 910 for determining the frequency band through which the bandwidth limiter 902 performs passing based on the magnitude of the component of the squared signal whose frequency is the fundamental frequency and the 2N multiple of the fundamental frequency of the signal-under-test.

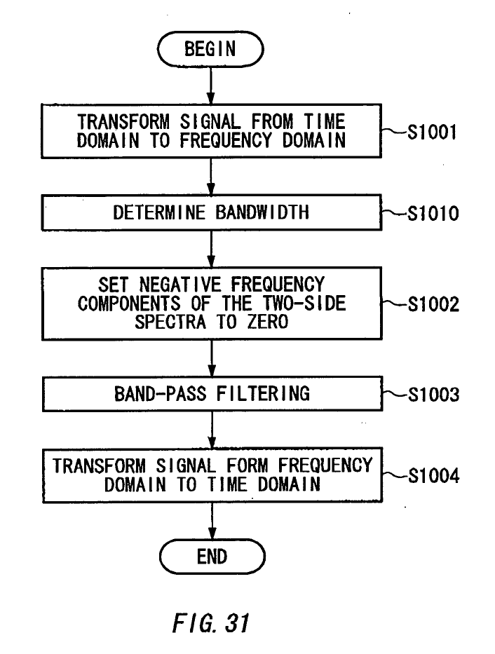

FIG. 31 is a flowchart showing a timing jitter estimating method by way of the analytic signal transformer 501 according to the second modified embodiment. First, the time domain to frequency domain transformer 901 performs FFT on the inputted squared signal to transform it to the two-sided spectrum signal of the frequency domain (S1001).

Then, the bandwidth limiter 902 replaces the negative frequency components with zeros for the transformed two-sided spectrum signal of the frequency domain outputted from the time domain to frequency domain transformer 901. Then, the bandwidth limiter 902 leaves only the components near the predetermined frequency of the input signal and replaces other frequency components with zeros for the one-sided spectrum signal which results from replacing the negative frequency components with zeros in S1002 so as to limit the bandwidth of the signal of the frequency domain (S1003). More particularly, the bandwidth limiter 902 extracts the components of the predetermined frequency band including the frequency which is the 2N multiple of the fundamental frequency of the signal-under-test from the two-sided spectrum signal which is the squared signal of the frequency domain. Accordingly, the timing jitter estimator 102 can obtain the timing jitter sequence with regard to the jitter component of the frequency band.

And the frequency domain to time domain transformer 903 performs inverse FFT on the band-limited one-sided spectrum signal so as to transform the signal of the frequency domain to the analytic signal of the time domain (S1004).

Alternatively, the bandwidth limiter 902 may perform S1002 after performing S1003. More particularly, the bandwidth limiter 902 first leaves only the components near the predetermined frequency of the input signal to replace other frequency components with zero, and limits the bandwidth of the signal of frequency domain. Then, bandwidth limiter 902 replaces the band-limited negative frequency component of the two-sided spectrum signal with zero.

In addition, if the analytic signal transformer 501 includes the bandwidth determining unit 910, the bandwidth determining unit 910 receives the two-sided spectrum signal of the squared signal outputted from the time domain to frequency domain transformer 901 in S1001. And the bandwidth determining unit 910, as shown in the principle (6) of the jitter measurement method, determines the frequency band through which the bandwidth limiter 902 performs passing on the basis of the magnitude of the component of the fundamental frequency of the signal-under-test, the magnitude of the 2N multiple of the fundamental frequency, and the inclination of the amplitude variations of the two-sided spectrum near the component of the fundamental frequency with regard to the two-sided spectrum (S1010). More particularly, the bandwidth determining unit 910 obtains K and L shown in the principle (6) of the jitter measurement method and calculates the bandwidth BW of the frequency band based on the values. And with the 2N multiple of the fundamental frequency being taken as the center, the frequency band with the bandwidth BW is determined as the frequency band through which the bandwidth limiter 902 performs passing. As the result, the bandwidth limiter 902 extracts the component of the frequency band determined by the bandwidth determining unit 910.

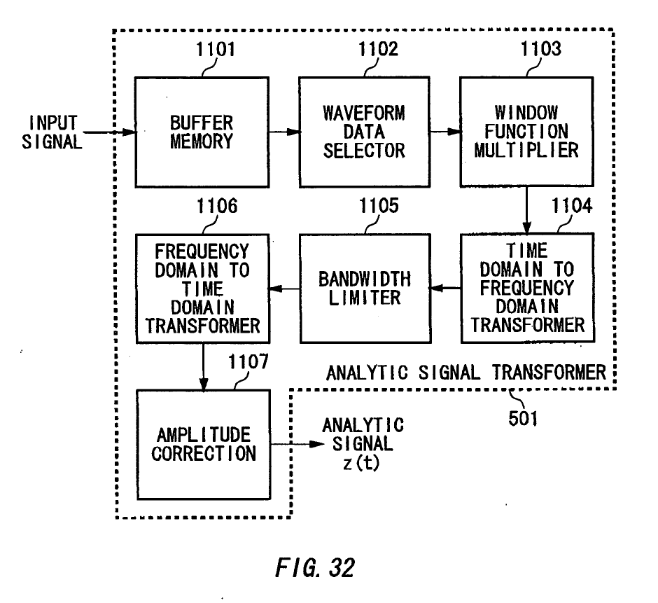

FIG. 32 shows the configuration of the analytic signal transformer 501 according to a third modified embodiment of this invention. The analytic signal transformer 501 according to this embodiment includes a buffer memory 1101, a waveform data selector 1102, a window function multiplier 1103, a time domain to frequency domain transformer 1104, a bandwidth limiter 1105, a frequency domain to time domain transformer 1106, and an inverse window function multiplier 1107.

The buffer memory 1101 stores the inputted squared signal. The waveform data selector 1102 sequentially extracts the signal stored in the buffer memory 1101 in order to overlap the sections of with a part of the signal previously selected. The window function multiplier 1103 multiplies each partial signal, which has been extracted by the waveform data selector 1102, by the window function. The time domain to frequency domain transformer 1104 transforms each partial signal multiplied by the window function to the two-sided spectrum in the frequency domain. The bandwidth limiter 1105 selects only the components near the predetermined frequency of the input signal from the two-sided spectrum transformed into the frequency domain. The frequency domain to time domain transformer transforms the output of the bandwidth limiter 1105 to the signal in the time domain. The inverse window function multiplier 1107 obtains the band-limited analytic signal by multiplying the signal transformed to the time domain by the reciprocal of the window function. The time domain to frequency domain transformer 1104 and the frequency domain to time domain transformer 1106 may perform transformation between the time and frequency domains by way of FFT and inverse FFT, respectively.

In addition, the analytic signal transformer 501 may further include the bandwidth determining unit 910 shown in FIG. 30. More particularly, the bandwidth determining unit 910 determines the frequency band to be extracted by the bandwidth limiter 1105 based on the two-sided spectrum outputted from the time domain to frequency domain transformer 1104, and sets it in the bandwidth limiter 1105. And the bandwidth limiter 1105 extracts the component of the frequency band set by the bandwidth determining unit 910 from the two-sided spectrum.

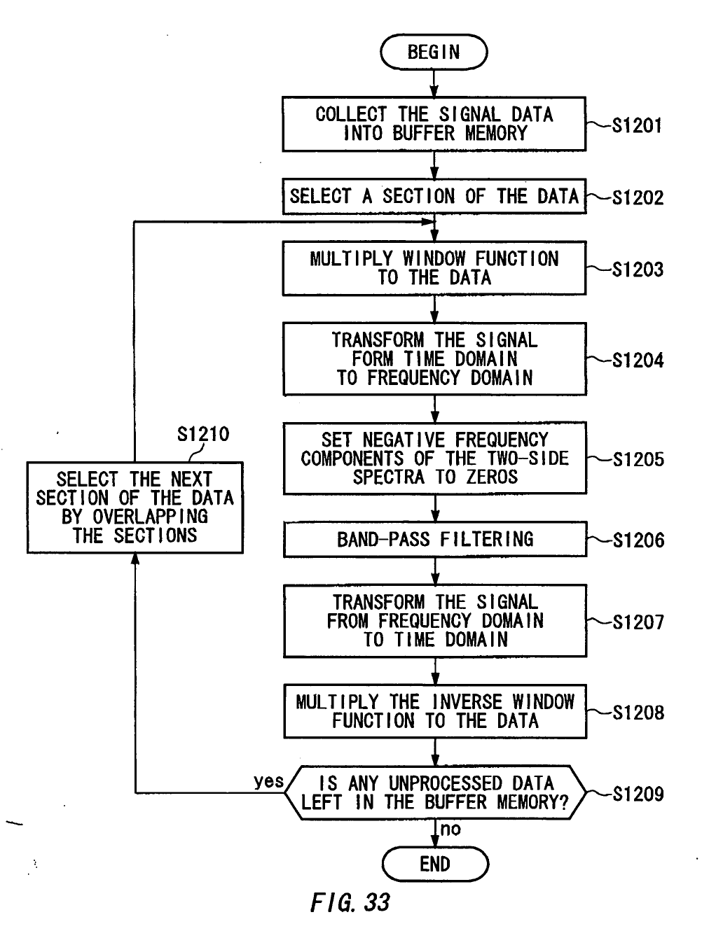

FIG. 33 is a flowchart showing the timing jitter estimating method by way of the analytic signal transformer 501 according to the third modified embodiment of this invention. First, the buffer memory 1101 stores the inputted squared signal (S1201). Then, the waveform data selector 1102 sequentially selects the signal stored in the buffer memory 1101 in order to overlap the section of the signal with a part of the signal previously selected (S1202). Then, the window function multiplier 1103 multiplies the partial signal, which has been selected, by the window function (S1203). Then, the time domain to frequency domain transformer 1104 performs FFT on the partial signal multiplied by the window function so as to transform the signal of the time domain to the two-sided spectrum in the frequency domain (S1204).

Then, the bandwidth limiter 1105 replaces the negative frequency components the two-sided spectrum in the frequency domain transformed with zeros (S1205). Then, the bandwidth limiter 1105 leaves only the component near the predetermined frequency of the inputted squared signal and replaces other frequency components with zero for the one-sided spectrum which results from replacing the negative frequency components with zeros so as to limit the bandwidth of the signal in the frequency domain (S1206). More particularly, the bandwidth limiter 1105 extracts the components of the predetermined frequency band including the frequency which is 2N multiple of the fundamental frequency of the signal-under-test.

Then, the frequency domain to time domain transformer 1106 performs inverse FFT on the one-sided spectrum signal whose bandwidth has been limited of the frequency domain so as to transform the signal in the frequency domain to the signal in the time domain (S1207). Then, the inverse window function multiplier 1107 multiplies the signal of the time domain transformed by the frequency domain to time domain transformer 1106 by the reciprocal of the window function multiplied in S1203 so as to obtain the band-limited analytic signal (S1208).

And the waveform data selector 1102 checks whether the data not yet processed is stored in the buffer memory or not (S1209). And if the data unprocessed is stored, the analytic signal transformer 501 repeats the processes from S1203 to S1209, sequentially selecting the signal from the buffer memory 1101 in order to overlap the segments of signal with a part of the signal previously selected (S1210).

Alternatively, the bandwidth limiter 1105 may alter S1205 and S1206. More particularly, the bandwidth limiter 1105 first leaves only the components near the predetermined frequency of the input signal to replace the other frequency components with zeros, and limits the bandwidth of the signal in the frequency domain (Sl206). And then, the bandwidth limiter 1105 replaces the negative frequency components of the two-sided spectrum with zeros (S1205).

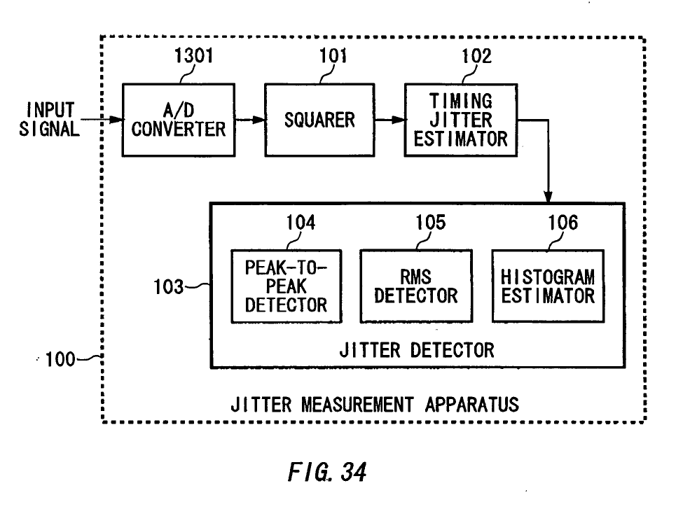

FIG. 34 shows the configuration of a jitter measurement apparatus 100 according to a fourth modified embodiment of this invention. The jitter measurement apparatus 100 of this embodiment includes an A/D converter 1301, a squarer 101, a timing jitter estimator 102, and a jitter detector 103. In the jitter measurement apparatus 100 according to this embodiment, members of the same symbols as those in FIG. 22 have the same function and configuration as those in FIG. 22, so they will not be described except the difference.

The A/D converter 1301 digitizes the input signal-under-test, which is an analog signal, so as to convert it into the discrete signal-under-test. The squarer 101 obtains the squared signal which results from squaring the discrete signal-under-test. Here, the A/D converter 1301 may be a high-speed A/D converter, a digitizer, or a digital sampling oscilloscope. Further, the A/D converter 1301 may be provided to the previous stage of the squarer 101 of the jitter measurement apparatus 100 shown in FIG. 24.

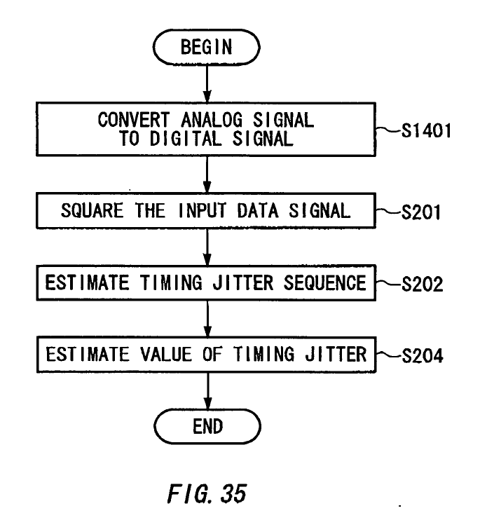

FIG. 35 is a flowchart showing a jitter measurement method by way of the jitter measurement apparatus 100 according to the fourth modified embodiment of this invention. In the jitter measurement method according to this embodiment, steps of the same symbols as those in FIG. 23 are the same as the steps where the process in FIG. 23 is performed, so they will not be described except the difference.

The A/D converter 1301 first samples (digitizes) an analog signal-under-test which is the object of the jitter measurement, and convert it into the digital signal (Sl410). And the squarer 101, the timing jitter estimator 102, and the jitter detector 103 perform S201, S202 and S204 respectively for the discrete signal-under-test.

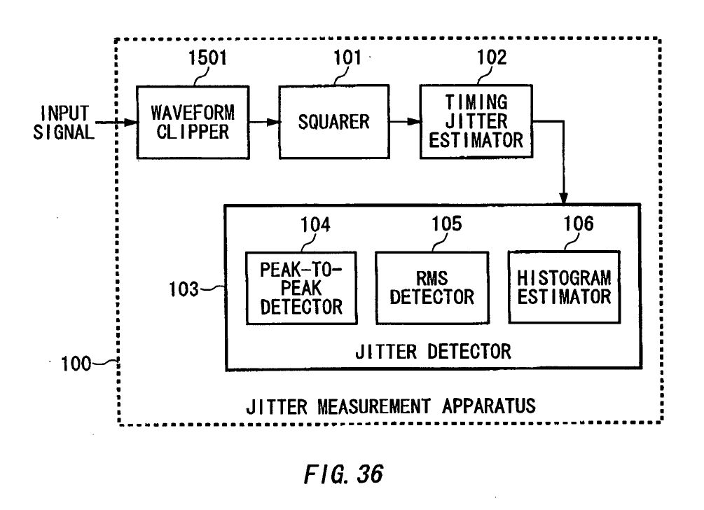

FIG. 36 shows the configuration of a jitter measurement apparatus 100 according to a fifth modified embodiment of this invention. The jitter measurement apparatus 100 of this embodiment includes a waveform clipper 1501, a squarer 101, a timing jitter estimator 102, and a jitter detector 103. In the jitter measurement apparatus 100 according to this embodiment, members of the same symbols as those in FIG. 22 have the same function and configuration as those in FIG. 22, so they will not be described except the difference.

The waveform clipper 1501 extracts the phase modulation (PM) component by removing the amplitude modulation (AM) component of the signal-under-test. Further, the A/ID converter 1301 may be provided to the previous stage of the squarer 101 of the jitter measurement apparatus 100 shown in FIG. 24.

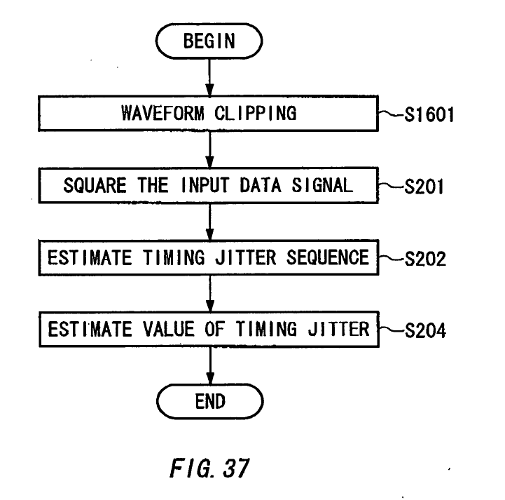

FIG. 37 is a flowchart showing a jitter measurement method by way of the jitter measurement apparatus 100 according to the fifth modified embodiment of this invention. In the jitter measurement method according to this embodiment, steps of the same symbols as those in FIG. 23 are the same as the steps where the process in FIG. 23 is performed, so they will not be described except the difference.

First, the waveform clipper 1501 extracts the phase modulation component by removing the amplitude modulation component from the inputted signal-under-test through the process shown in the process (8) of the jitter measurement method. Then, the squarer 101 raises the signal-under-test, which is outputted by the waveform clipper 1501 and whose amplitude modulation component has been removed, to the 2N-th power, and obtains the squared signal (S201). And the timing jitter estimator 102 and the jitter detector 103 perform the processes of S202 and S204 respectively on the basis of the squared signal outputted by the squarer 101.

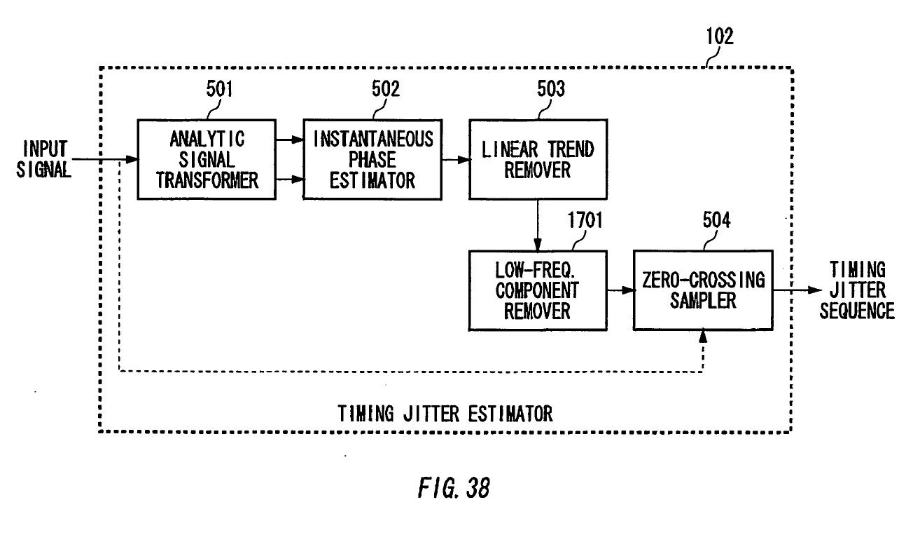

FIG. 38 shows the configuration of a timing jitter estimator 102 according to a sixth modified embodiment of this invention. The timing jitter estimator 102 according to this embodiment includes an analytic signal transformer 501, an instantaneous phase estimator 502, a linear trend remover 503, a low frequency component remover 1701, and a zero-crossing sampler 504. In the timing jitter estimator 102 according to this embodiment, members of the same symbols as those in FIG. 26 have the same function and configuration as those in FIG. 26, so they will not be described except the difference. The low frequency component remover 1701 removes the low frequency component of the instantaneous phase noise outputted by the linear trend remover 503.

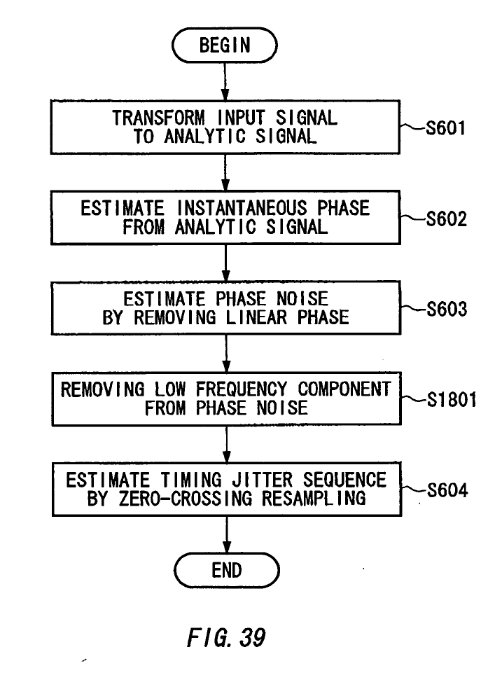

FIG. 39 is a flowchart showing a timing jitter estimating method by way of the jitter measurement apparatus 100 according to the sixth modified embodiment of this invention. In the jitter measurement method according to this embodiment, steps of the same symbols as those in FIG. 27 are the same as the steps where the process in FIG. 27 is performed, so they will not be described except the difference.

The low frequency component remover 1701 removes the low frequency component of the instantaneous phase noise outputted by the linear trend remover 503 in S603 (S1801). And the zero-crossing sampler 504 outputs the timing jitter sequence on the basis of the instantaneous phase noise whose low frequency component has been removed (S604).

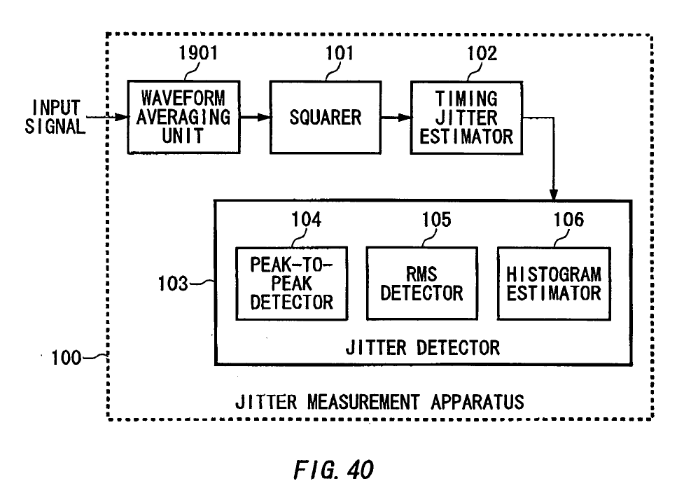

FIG. 40 shows the configuration of a jitter measurement apparatus 100 according to a seventh modified embodiment of this invention. The jitter measurement apparatus 100 according to this embodiment waveform averaging means 1901, a squarer 101, a timing jitter estimator 102, and a jitter detector 103. In the jitter measurement apparatus 100 according to this embodiment, members of the same symbols as those in FIG. 22 have the same function and configuration as those in FIG. 22, so they will not be described except the difference.

The waveform averaging means 1901 averages the signal-under-test by synchronizing them with the period of the data sequence of the signal-under-test. Further, the waveform averaging means 1901 may be provided to the previous stage of the squarer 101 of the jitter measurement apparatus 100 shown in FIG. 26.

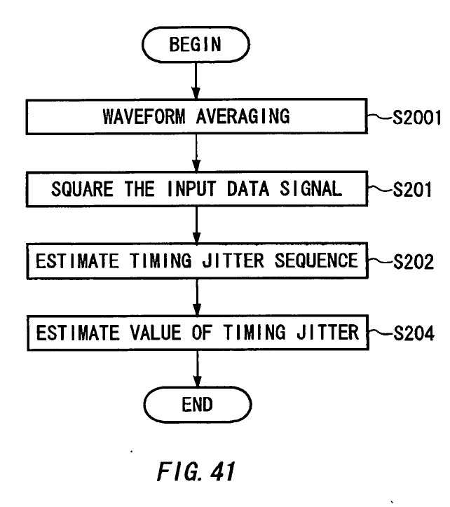

FIG. 41 is a flowchart showing a timing jitter estimating method by way of the jitter measurement apparatus 100 according to the seventh modified embodiment of this invention. In the jitter measurement method according to this embodiment, steps of the same symbols as those in FIG. 23 are the same as the steps where the process in FIG. 23 is performed, so they will not be described except the difference.

First, the waveform averaging means 1901 obtains the averaged signal-under-test by averaging the data sequence of each period in response to the fundamental frequency of the signal-under-test with regard to the inputted signal-under-test (S2001). The squarer 101, the timing jitter estimator 102, and the jitter detector 103 performs the processes of S201, S202 and S204 for the signal-under-test averaged by the squarer 101.

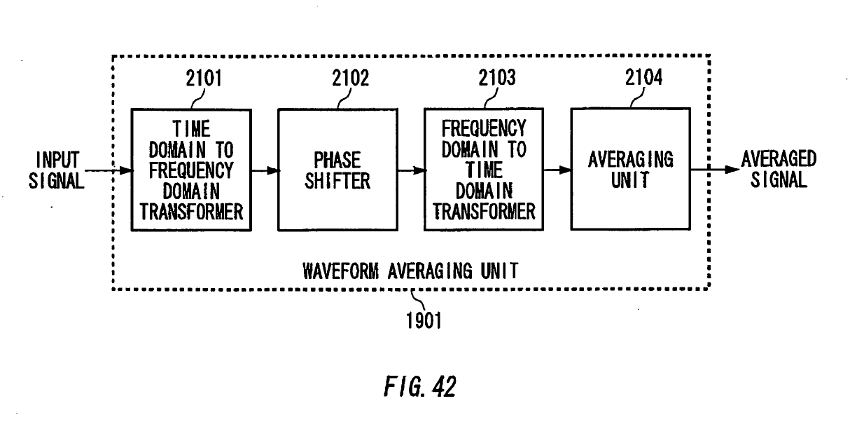

FIG. 42 shows the configuration of the waveform averaging means 1901 according to an exemplary embodiment of this invention. The waveform averaging means 1901 includes a time domain to frequency domain transformer 2101, a phase shifter 2102, a frequency domain to time domain transformer 2103, and averaging means 2104.

The time domain to frequency domain transformer 2101 transforms the inputted signal-under-test to the complex spectrum signal in the frequency domain. The phase shifter 2102 shifts the phase of each frequency component of the complex spectrum signal outputted by the time domain to frequency domain transformer 2101 by rotating the phase as much as a predetermined amount. The frequency domain to time domain transformer 2103 outputs the signal-under-test whose phase has been shifted by transforming the complex spectrum signal, whose phase has been shifted, to the signal in the time domain. The averaging means 2104 obtains the averaged signal-under-test on the basis of the signal-under-test whose phase has been shifted.

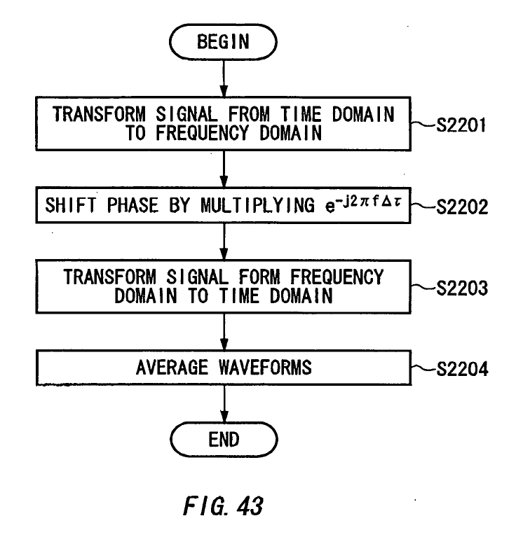

FIG. 43 is a flowchart showing a waveform averaging method by way of the waveform averaging means 1901 according to an exemplary embodiment of this invention. First, the time domain to frequency domain transformer 2101 transforms the inputted signal-under-test to the complex spectrum in the frequency domain (S2201). Then, the phase shifter 2102, as shown in the principle (9) of the jitter measurement method, shifts the phase of each frequency component of the complex spectrum signal in the frequency domain outputted by the time domain to frequency domain transformer 2101 by rotating the phase as much as a predetermined amount (S2202).

Then, the frequency domain to time domain transformer 2103 transforms the complex spectrum signal, whose phase has been shifted, to the signal in the time domain, and outputs the signal-under-test whose phase has been shifted (S2203). And the averaging means 2104 obtains the averaged signal-under-test by adding and averaging the signal-under-test which has been inverse transformed by the frequency domain to time domain transformer 2103 and whose phase has been shifted.

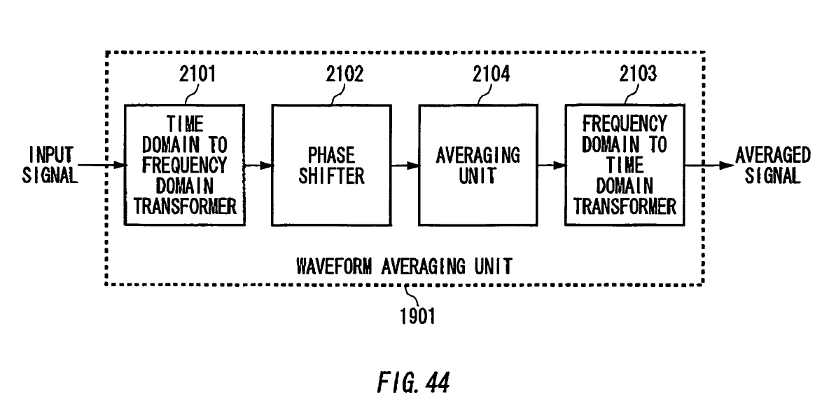

FIG. 44 shows the configuration of waveform averaging means 1901 according to an eighth modified embodiment of this invention. The waveform averaging means 1901 according to this embodiment is configured that the output of the phase shifter 2102 is inputted to the averaging unit 2104, the output of the averaging unit 2104 is inputted to the frequency domain to time domain transformer 2103, and the output of the frequency domain to time domain transformer 2103 is taken as the output of the waveform averaging means 1901.

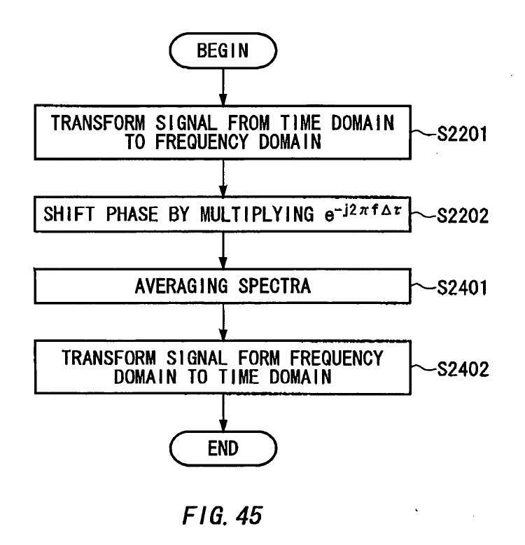

FIG. 45 is a flowchart showing a waveform averaging method by way of the waveform averaging means 1901 according to the eighth modified embodiment of this invention. The waveform averaging method of this embodiment is the waveform averaging method shown in FIG. 43 where the process order of S2204 and S2203 is altered. In other words, the averaging unit 2104 averages the complex spectrum signal in the frequency domain which is outputted by whose phase has been shifted by the phase shifter 2102, and supplies the complex spectrum in the frequency domain which has been averaged to the frequency domain to time domain transformer 2103 (S2204). And the frequency domain to time domain transformer 2103 performs inverse transformation on the complex spectrum in the frequency domain which has been averaged to the signal in the time domain (S2203).

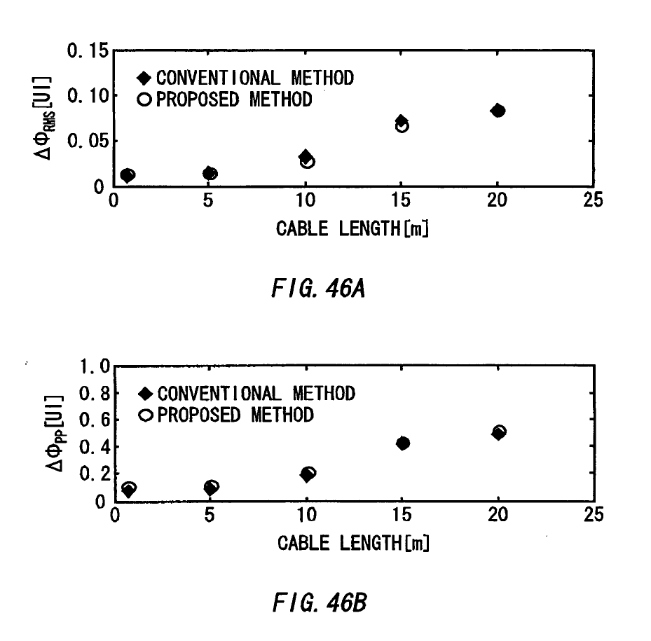

FIG. 46 compares and shows the timing jitter value of the data signal measured by way of jitter measurement method of the present invention and the timing jitter value measured by the eye diagram method using the sampling oscilloscope by way of the conventional method. This measurement is the result of transmitting the data signal which is to be the signal-under-test through a cable of 1 to 20 meters in length and plotting the RMS value (FIG. 46A) and the peak to peak value (FIG. 46B) of the timing jitter which occurs at the end of the cable caused by the data pattern and the effect of the transmission characteristics of the cable for each length of the cable. As shown in FIG. 46, according to the jitter measurement method of the present invention, it is possible to obtain the jitter value which is compatible with the eye diagram method.

According to the jitter measurement apparatus and the jitter measurement method of the present invention, the fundamental clock component of the signal is reproduced by squaring the data signal, and the instantaneous phase noise of the fundamental clock component is obtained, whereby it is possible to obtain the jitter sequence from the data signal with high precision in short time, and to considerably reduce the cost of the jitter measurement.

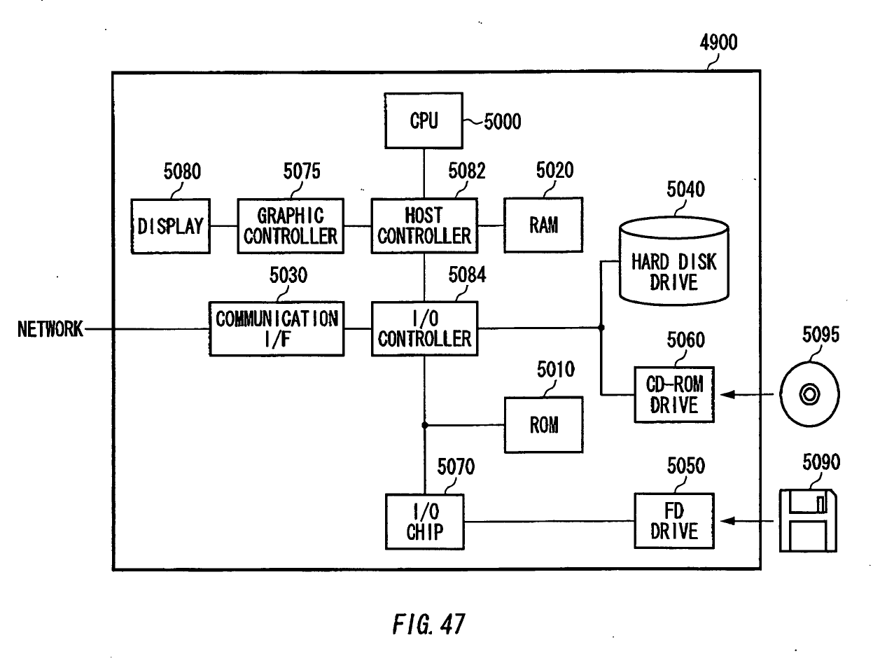

FIG. 47 shows an example of the hardware configuration of a computer 4900 according to an exemplary embodiment of the present invention. The computer 4900 according to this embodiment obtains the signal-under-test by, e.g. an A/D converter 1301 provided in the computer 4900, and functions as the jitter measurement apparatus 100. The computer 4900 includes a CPU peripheral unit which includes a CPU 5000, a RAM 5020, a graphic controller 5075, and a display 5080 being coupled to each other by a host controller 5082, an input/output unit which includes a communication interface 5030, a hard disk drive 5040, and a CD-ROM drive 5060 being coupled to the host controller 5082 by an input/output controller 5084, and a legacy input/output unit which includes a ROM 5010, a floppy disk drive 5050, and an input/output chip 5070 being coupled to the input/output controller 5084.

The host controller 5082 couples the RAM 5020, the CPU 5000 and the graphic controller 5075 which access the RAM 5020 at a high transmission rate. The CPU 5000 operates based on a program which is stored in the ROM 5010 and the RAM 5020 to control each unit. The graphic controller 5075 obtains image data generated on a frame buffer which is provided in the RAM 5020 by the CPU 5000, and shows the image on the display 5080. Alternatively, the graphic controller 5075 may include the frame buffer for storing the image data generated by the CPU 5000.

The input/output controller 5084 couples the host controller 5082 to the communication interface 5030, the hard disk drive 5040, and the CD-ROM drive 5060 which are relatively high-speed input/output devices. The communication interface 5030 communicates with other devices via a network. The hard disk drive 5040 stores the program and data which is used by the CPU 5000 in the computer 4900. The CD-ROM drive 5060 reads the program and data from the CD-ROM 5095, and supplies it to the hard disk drive 5040 via the RAM 5020.

To the input/output controller 5084, the ROM 5010, the floppy disk drive 5050, and the input/output chip 5070, which are relatively low-speed devices are coupled. The ROM 5010 stores a boot program that the computer 4900 executes when driven or a program depending upon the hardware of the computer 4900. The floppy disk drive 5050 reads a program or data from the floppy disk 5090, and supplies it to the hard disk drive 5040 via the RAM 5020. The input/output chip 5070 couples the floppy disk drive 5050 or various input/output devices via a parallel port, a serial port, a keyboard port, a mouse port, etc.

The program provided to the hard disk drive 5040 via the RAM 5020 is provided by a user, being stored on a computer-readable medium such as the floppy disk 5090, the CD-ROM 5095, or an IC card. The program is read from the computer-readable medium, installed on the hard disk drive 5040 in the computer 4900 via the RAM 5020, and executed in the CPU 5000.

The program which is installed in the computer 4900 and allows the computer 4900 to function as the jitter measurement apparatus 100 includes a squaring module, a timing jitter estimating module, and a jitter detecting module which includes a peak to peak detecting module, an RMS detecting module, and/or a histogram estimating module. These program and modules are driven by the CPU 5000, and allows the computer 4900 to function as the squarer 101, the timing jitter detector 102, and the jitter detector 103 which includes the peak to peak detector 104, the RMS detector 105, and the histogram detector 106 respectively.

In addition, the program may further include a carrier amplifying module, a jitter amplitude correcting module, an A/D converting module, a waveform clipping module, and/or a waveform averaging module. These program and modules are driven by the CPU 5000, and allows the computer 4900 to function as the carrier amplifier 301, the jitter amplitude corrector 302, the A/D converter 1301, the waveform clipper 1501, and/or the waveform averaging unit 1901.

In addition, the timing jitter estimating module includes an analytic signal transforming module, an instantaneous phase estimating module, a linear trend removing module, and a resampling module. These program and modules are driven by the CPU 5000, and allows the computer 4900 to function as the analytic signal transformer 501, the instantaneous phase estimator 502, the linear trend remover 503, and the zero-crossing sampler 504. In addition, the timing jitter estimating module may further include a low-frequency component removing module for allowing the computer 4900 to function as the low-frequency component remover 1701.

Here, the analytic signal transforming module may include a band-pass filtering module and a Hilbert transforming module for allowing the computer 4900 to function as the band-pass filter 701 and the Hilbert transformer 702. Alternatively, the analytic signal transforming module may include a time domain to frequency domain transforming module, a bandwidth limiting module, and a frequency domain to time domain transforming module for allowing the computer 4900 to function as the time domain to frequency domain transformer 901, the bandwidth limiter 902, and the frequency domain to time domain transformer 903.

And alternatively, the analytic signal transforming module may further include a buffer memory managing module, a waveform data module, a window function multiplying module, a time domain to frequency domain transforming module, a bandwidth limiting module, a frequency domain to time domain transforming module and an amplitude correcting module for allowing the computer 4900 to function as the buffer memory 1101, the waveform data selector 1102, the window function multiplier 1103, the time domain to frequency domain transformer 1104, the bandwidth limiter 1105, the frequency domain to time domain transformer 1106 and the amplitude corrector 1107.

The program or modules shown above may be stored on an external computer-readable medium. As the computer-readable medium, in addition to the floppy disk 5090 and the CD-ROM 5095, an optical computer-readable medium such as a DVD or PD, an electro-magnetic computer-readable medium such as an MD, a tape medium, a semiconductor memory such as an IC card, etc. can be used. In addition, by way of a storing device such as a hard disk or RAM provided in a server system coupled to the dedicated network or the Internet as the computer-readable medium, the program may be provided to the computer 4900 via the network.

Although the present invention has been described by way of exemplary embodiments, it should be understood that those skilled in the art might make many changes and substitutions without departing from the spirit and the scope of the present invention which is defined only by the appended claims.

As obvious from the description above, according to the present invention, by obtaining the timing jitter of a signal-under-test on the basis of the squared signal which results from raising the signal-under-test to the 2N-th power, it is possible to obtain the jitter sequence from the data signal with high precision in short time, and to considerably reduce the cost of the jitter measurement.

1. A jitter measurement apparatus for measuring jitter of a signal-under-test, comprising:
a squarer for obtaining a squared signal which results from raising said signal-under-test to the 2N-th power (N is a positive integer); and
a timing jitter estimator for obtaining a timing jitter sequence of said signal-under-test based on said squared signal.

2. A jitter measurement apparatus as claimed in claim 1,
wherein said timing jitter estimator comprises a bandwidth limiter for extracting a component near a predetermined frequency band which includes a 2N multiple of a fundamental frequency of said signal-under-test from said squared signal, and
obtains said timing jitter sequence with regard to a jitter component of said signal-under-test within said frequency band.

3. A jitter measurement apparatus as claimed in claim 2, further comprising:
a bandwidth determining unit for determining said frequency band based on magnitude of a component of said fundamental frequency of said signal-under-test and a component of a 2N multiple of said fundamental frequency with regard to said squared signal.

4. A jitter measurement apparatus as claimed in claim 1, further comprising:
a carrier amplifier for amplifying a carrier component of said squared signal, which is a 2N multiple of a fundamental frequency of said signal-under-test; and
a jitter amplitude corrector for correcting amplitude of said timing jitter sequence obtained by said timing jitter estimator based on a ratio at which said carrier component is amplified by said carrier amplifier, wherein said timing jitter estimator obtains said timing jitter sequence based on said squared signal whose carrier component has been amplified.

5. A jitter measurement apparatus as claimed in claim 1,
wherein said timing jitter estimator comprises:
an analytic signal transformer for transforming said squared signal to an analytic signal;
an instantaneous phase estimator for obtaining an instantaneous phase of said analytic signal;
a linear trend remover for obtaining an instantaneous phase noise by removing a linear phase from said instantaneous phase; and
a resampler for resampling data in response to timing which is closest to a predetermined phase of said squared signal among a data sequence of said instantaneous phase noise as instantaneous phase noise data, and outputting said timing jitter sequence, and
said analytic signal transformer comprises:
a band-pass filter for removing a component except a predetermined frequency band which includes a 2N multiple of said fundamental frequency of said signal-under-test; and
a Hilbert transformer for generating a Hilbert transform pair of said squared signal, whose component except a predetermined frequency band has been removed, by performing Hilbert transform on said squared signal whose component except said predetermined frequency band has been removed.

6. A jitter measurement apparatus as claimed in claim 1,
wherein said timing jitter estimator comprises:
an analytic signal transformer for transforming said squared signal to an analytic signal;
an instantaneous phase estimator for obtaining an instantaneous phase of said analytic signal;
a linear trend remover for obtaining an instantaneous phase noise by removing a linear phase from said instantaneous phase; and
a resampler for resampling data in response to timing which is closest to a predetermined phase of said squared signal among a data sequence of said instantaneous phase noise as instantaneous phase noise data, and outputting said timing jitter sequence, and
said analytic signal transformer comprises:
a time domain to frequency domain transformer for transforming said squared signal to a spectrum signal of a frequency domain;
a bandwidth limiter for extracting components of said spectrum near a predetermined frequency band which includes a 2N multiple of a fundamental frequency of said signal-under-test; and
a frequency domain to time domain transformer for transforming an output of said bandwidth limiter to said analytic signal in a time domain.

7. A jitter measurement apparatus as claimed in claim 6,
wherein said analytic signal transformer further comprises a bandwidth determining unit for determining said frequency band based on magnitude of a component of said fundamental frequency of said signal-under-test, magnitude of a component of a 2N multiple of said fundamental frequency, and inclination of amplitude variations of a spectrum near a component of said fundamental frequency or a 2N multiple of said fundamental frequency with regard to said spectrum.

8. A jitter measurement apparatus as claimed in claim 7,
wherein said bandwidth determining unit calculates a bandwidth BW of said frequency band based on the following equation, and determines a frequency band with said bandwidth BW whose center is a 2N multiple of said fundamental frequency as said predetermined frequency band:
$$BW = 2 ( 2 {f}_{0} - \frac{3 {Kf}_{0} - L}{2 K} ) ,$$
where f₀ represents said fundamental frequency of said signal-under-test, −K represents said inclination of said amplitude variations of said spectrum near said component of said fundamental frequency or said 2N multiple of said fundamental frequency (K represents a decreasing amount of a coordinate in an amplitude direction of said amplitude variations with being apart from said fundamental frequency or said 2N multiple of said fundamental frequency as much as a unit frequency near said component of said fundamental frequency or said 2N multiple of said fundamental frequency), and L represents a value which results from subtracting magnitude of said component of said 2N multiple of said fundamental frequency from magnitude of said component of said fundamental frequency.

9. A jitter measurement apparatus as claimed in claim 1, further comprising:
an A/D (analog to digital) converter said input signal-under-test of an analog signal into a digital signal.

10. A jitter measurement apparatus as claimed in claim 1, further comprising:
waveform averaging means for obtaining said signal-under-test, which is averaged, by averaging a data sequence of said signal-under-test for each period in response to said fundamental frequency of said signal-under-test.

11. A jitter measurement method for measuring jitter of a signal-under-test by a jitter measurement apparatus, comprising:
a squaring step of obtaining a squared signal which results from raising said signal-under-test to the 2N-th power (N is a positive integer); and
a timing jitter estimating step of obtaining a timing jitter sequence of said signal-under-test based on said squared signal.

12. A computer-readable medium for storing a program for a jitter measurement apparatus for measuring jitter of a signal-under-test, said program allowing said jitter measurement apparatus to function as:
a squarer for obtaining a squared signal which results from raising said signal-under-test to the 2N-th power (N is a positive integer); and
a timing jitter estimator for obtaining a timing jitter sequence of said signal-under-test based on said squared signal.
